(19) United States
(12) Patent Application Publication
(10) Pub. No.: US 2005/0258282 A1
(43) Pub. Date: Nov. 24, 2005

(54) Discharge nozzle with function for preventing backflow of content and liquid container comprising discharge nozzle

(76) Inventor: Tadashi Hagihara, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/513,660

(22) PCT Filed: Jun. 21, 2002
(86) PCT No.: PCT/JP02/06255

§ 371 Date: Jul. 27, 2005

(30) Foreign Application Priority Data
May 8, 2002 (JP) 2002-132978
May 8, 2002 (JP) 2002-132979
May 8, 2002 (JP) 2002-132980
May 8, 2002 (JP) 2002-132981
May 8, 2002 (JP) 2002-132982
May 8, 2002 (JP) 2002-132983

(51) Int. Cl. B05B 1/30

(52) U.S. Cl. 239/571

(57) ABSTRACT

In a discharge nozzle which is to be provided at a discharge opening of a flexible container to be deformed by external pressure to discharge contents, a liquid channel in the nozzle is penetrated at all times from an inlet on the side of a container body to a discharge opening and is partially composed of a gap channel defined by a plurality of faces, and the gap channel is of such dimensions that a contents liquid stagnates under normal pressure due to its viscosity or surface tension and does not easily flow there through, whereby the discharge nozzle is provided with a function for preventing a backflow of contents wherein the contents can be discharged by pressing the container body at the time of discharge, while the contents in the liquid channel of the discharge nozzle and the outer air are prevented from flowing back into the container body when the pressing force is released.

### TECHNICAL FIELD

The present invention relates to a discharge nozzle with a function for preventing a backflow at a container opening portion, which prevents the backflow of contents and air into a container body on discharging from the container body the contents (fluid), particularly a so-called semifluid, such as a creamy or gel liquid, having a viscosity higher than water. The present invention also relates to a container provided with the same discharge nozzle.

### BACKGROUND ART

Priorly, various arts have been proposed to prevent, after contents are discharged from a container such as a tube, the contents from flowing back into the container or the container from taking in air. All of these have employed some type of backflow prevention valves (hereinafter, check valves.)

For example, as described in JP-A-2001-301779, one provided with a flap-like check valve, as described in JP-A-2001-278297, one provided with a trumpet-like check valve, as described in JP-A-2001-40089, one provided with a check valve of a type to charge a piece-like valve member (hereinafter, a valve piece) by a spring force, and as described in JP-A-2000-289756, one wherein a freely movable valve piece is provided as a check valve are representative arts, and a wide variety of check valves have been proposed.

These all have had relatively simple mechanisms as to valve mechanisms in most cases and, therefore, have been efficacious arts in terms of cost.

However, all of the above-described prior arts have been of a type with a valve member for mechanically shutting an opening portion.

Of the above-described prior arts, in the one with a flap-like valve member, mobility of its hinge portion greatly affects the valve function, and in the other ones of a type wherein a valve piece moves, the moving conditions of the valve piece determine the valve function itself. In addition, with a low-viscosity liquid, these all function with relatively no problems and also have high valve functions, however, as for a creamy or gel-state high-viscosity liquid, the liquid itself works as a damper of the function member, and the valve functions are remarkably lowered. In such a case, out of the above-described prior arts, in only the one of a type wherein the valve piece is pressed against the opening by a spring force, the valve function can be relatively expected. However, it becomes necessary to increase the spring force as the viscosity is heightened, and in accordance therewith, discharge ability is also deteriorated, thus it is obvious that not only returning but also discharging become difficult.

As such, since backflow prevention has been provided exclusively by shutting the opening portion, it is no exaggeration to say that there is virtually no art that can be applied to a high-viscosity liquid.

In addition, particularly for tube-type containers, although it has been considered that filling therein a low-viscosity liquid close to water is difficult since it may leak, it has been known that if these can be widely used for relatively low-viscosity liquids not to mention high-viscosity liquids, versatility and a high-degree of availability can be realized as containers.

Therefore, an always-open-type discharge nozzle with a function for preventing a backflow of contents and a liquid container provided with the same of the present invention has been made to solve the problems of the prior arts as described above, and provides a breakthrough discharge nozzle and a liquid container provided with the same which can display a backflow preventing function without depending on such a mechanical structure as in the prior arts and restrict a backflow of the contents and air in an always-open state.

### DISCLOSURE OF THE INVENTION

That is, the discharge nozzle with a function for preventing a backflow of contents of the present invention has the following features:

(1) In a discharge nozzle which is to be provided at a discharge opening of a flexible container to be deformed by external pressure to discharge contents, the discharge nozzle has a liquid channel, which penetrates the discharge nozzle at all times from an inlet on the side of a container body to a discharge opening and is partially composed of a gap channel defined by a plurality of faces, and the gap channel is of such dimensions that a contents liquid stagnates under normal pressure due to the viscosity or surface tension of the contents liquid and does not easily flow therethrough, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(2) The plurality of faces forming the gap are curved faces.

(3) The plurality of faces forming the gap are plane faces.

(4) The plurality of faces forming the gap are spherical faces.

(5) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a minute channel having a minute cross-section, and the minute channel is of such dimensions that a contents liquid stagnates under normal pressure due to the viscosity or surface tension of the contents liquid and does not easily flow therethrough, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(6) The minute channel is formed by a thread groove and a face.

(7) The minute channel is formed by protruded threads and a face.

(8) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening, the liquid channel is of such narrow dimensions that contents stagnate in the channel under normal pressure due to the viscosity or surface tension of the contents and do not easily flow therethrough, and moreover, the liquid channel has a reverse flow channel for a flowing of at least one time in a direction opposite to a discharging direction toward the discharge opening from the container body, whereby the discharge nozzle is provided with such a function for preventing a backflow of contents that contents can be discharged by pressing a container body at the time of discharge, while a contents in the liquid channel of the discharge nozzle and the outer air are prevented from flowing back into the container body when the pressing force is released.

(9) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening, the liquid channel is of such narrow dimensions that the contents stagnate in the channel under normal pressure due to the viscosity or surface tension of the contents and do not easily flow therethrough, and moreover, the liquid channel has a bending channel for bending at least once the contents in flow direction with respect to a discharging direction toward the discharge opening from the container body, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(10) A part of the liquid channel is composed of a gap channel defined by a plurality of faces.

(11) A part of the liquid channel is a minute channel having a minute cross-section.

(12) The minute channel is formed by a thread groove and a face.

(13) The minute channel is formed by protruded threads and a face.

(14) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces and a minute channel having a minute cross-section, and the gap channel and the minute channel are of such dimensions that a contents liquid stagnates under normal pressure due to the viscosity or surface tension of the contents liquid and does not easily flow therethrough, whereby the discharge nozzle is provided with such a function for preventing backflow of contents that contents can be discharged by pressing a container body at the time of discharge, while contents in the liquid channel of the discharge nozzle and the outer air are prevented from flowing back into the container body when the pressing force is released.

(15) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces or a minute channel having a minute cross-section, and furthermore, the channel forms a reciprocating channel having a backflow channel for a flowing of at least one time in a direction opposite to a discharging direction toward the discharge opening from the container body, and the gap channel is of such dimensions that a contents liquid stagnates under normal pressure due to the viscosity or surface tension of the contents liquid and does not easily flow therethrough, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(16) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces or a minute channel having a minute cross-section, and furthermore, the channel has a bending channel for bending at least once contents in flow direction with respect to a discharging direction toward the discharge opening from the container body, and the gap channel is of such dimensions that a contents liquid stagnates under normal pressure due to the viscosity or surface tension of the contents liquid and does not easily flow therethrough, whereby the discharge nozzle is provided with such a function for preventing a backflow of contents that contents can be discharged by pressing a container body at the time of discharge, while a contents in the liquid channel of the discharge nozzle and the outer air are prevented from flowing back into the container body when the pressing force is released.

(17) In a discharge nozzle which is to be provided at a discharge opening of a flexible container to be deformed by external pressure to discharge the contents, the discharge nozzle has a liquid channel, which penetrates the discharge nozzle from an inlet on the side of a container body to a discharge opening and is partially composed of a gap defined by a plurality of faces and a minute channel having a minute cross-section, and furthermore, the channel forms a reciprocating channel having a backflow channel for a flowing of at least one time in a direction opposite to a discharging direction toward the discharge opening from the container body, and the gap channel is of such dimensions that a contents liquid stagnates under normal pressure due to the viscosity or surface tension of the contents liquid and does not easily flow therethrough, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(18) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces and a minute channel having a minute cross-section, and furthermore, the channel has a bending channel for bending at least once contents in flow direction with respect to a discharging direction toward the discharge opening from the container body, and the gap channel is of such dimensions that a contents liquid stagnates under normal pressure due to the viscosity or surface tension of the contents liquid and does not easily flow therethrough, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(19) The plurality of faces forming the gap are curved faces.

(20) The plurality of faces forming the gap are plane faces.

(21) The plurality of faces forming the gap are spherical faces.

(22) The minute channel is formed by a thread groove and a face.

(23) The minute channel is formed by protruded threads and a face.

(24) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to the viscosity or surface tension of the contents liquid and does not easily flow therethrough so as to restrict a flow of contents in a normal condition, and furthermore, the channel secures a sufficiently long tube length in a limited space of a container discharge opening by being provided with two or more reverse flow channels for a flowing of at least one time in a direction opposite to an outflow direction toward the discharge opening from the container body, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(25) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to the viscosity or surface tension of the contents liquid and does not easily flow therethrough so as to restrict a flow of contents in a normal condition, and furthermore, the channel secures a sufficiently long tube length in a limited space of a container discharge opening by being provided with a discharge channel for reaching the discharge opening while reversing in a direction orthogonal to an outflow direction toward the discharge opening from the container body, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(26) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to the viscosity or surface tension of the contents liquid and does not easily flow therethrough so as to restrict a flow of contents in a normal condition, and furthermore, the channel secures a sufficiently long tube length in a limited space of a container discharge opening by being formed into a helicoidal shape, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(27) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to the viscosity or surface tension of the contents liquid and does not easily flow therethrough so as to restrict a flow of the contents in a normal condition, and furthermore, the channel secures a sufficiently long tube length in a limited space of a container discharge opening by being formed into a spiral shape, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(28) In a discharge nozzle which is to be provided at a discharge opening of a flexible container to be deformed by external pressure to discharge contents, the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to the viscosity or surface tension of the contents liquid and does not easily flow therethrough so as to restrict a flow of the contents in a normal condition, and furthermore, the channel secures a sufficiently long tube length in a limited space of a container discharge opening by being formed into a maze-like shape, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(29) In a discharge nozzle which is to be provided at a discharge opening of a flexible container to be deformed by external pressure to discharge contents, the discharge nozzle has a liquid channel, which is partially composed of a gap defined by a plurality of faces or a minute channel having a minute cross-section, the liquid channel is of such dimensions that a contents liquid stagnates under normal pressure due to the viscosity or surface tension of the contents liquid and does not easily flow therethrough, and a check valve is provided at a discharge opening portion, whereby the discharge nozzle is provided with such a function for preventing a backflow of contents that contents can be discharged by pressing a container body at the time of discharge, while contents in the liquid channel of the discharge nozzle and the outer air are prevented from flowing back into the container body when the pressing force is released.

(30) The check valve is an elastic body plate provided with at least one slit which is closed in a normal condition.

(31) The check valve is a plate-like valve which shuts the discharge opening portion of the nozzle in a normal condition.

(32) The check valve is a ball- or piece-like valve which shuts the discharge opening portion of the nozzle in a normal condition.

In addition, a liquid container of the present invention is characterized in being provided with the discharge nozzle with a function for preventing a backflow of contents according to any of the above-described (1) through (32).

### BEST MORE FOR CARRYING OUT THE INVENTION

Hereinafter, embodiments of a discharge nozzle (hereinafter, a nozzle of the present invention) with a function for preventing a backflow of contents and a liquid container provided with the same (hereinafter, a container of the present invention) of the present invention will be described.

### Embodiment 1

FIG. 1 through FIG. 13 show a first embodiment of an always-open-type discharge nozzle of the present invention and a container provided with the same.

FIG. 1 shows an overall perspective view in a condition where a cap has been removed. In FIG. 1, a container 1 of the present invention has a cylindrical portion 3 integrally provided on an upper portion of a container body 2, and at its front end (upper end), a plane portion 4 is provided, and, at its center, an opening portion 5 from which a discharge opening 12 of a nozzle of the present invention, which will be described later, is protruded is provided. On the outer circumference of the cylindrical portion 3, a male screw 6 is formed, and by this screw 6, a cap 7 is screwed and fixed. In this embodiment, the container body 2 is provided as a tube container.

FIG. 2 is a longitudinal sectional view showing the center of a main part in the vicinity of an opening portion of a container of the present invention.

The container body 2 and cylindrical portion 3 are integrally formed from polyethylene or a composite material by an ordinary method. The container body may be any flexible container to be deformed by an external pressure applied by grasping by hand or the like to push out the contents from its discharge opening, and in addition to the very common tube shown in FIG. 1, a pouch-like container or the like is also preferable. As shown in FIG. 2, inside the cylindrical portion 3, a nozzle 8 of the present invention is inserted. The nozzle 8 of the present invention is constructed in such a manner where a columnar member 10 is inserted inside a cylindrical member 9. FIG. 3 is a cross-sectional view along A-A of FIG. 2. As shown in FIG. 4, the cylindrical member 9 is provided with a plane portion 11 at its upper end and is provided with a discharge opening 12 at a center portion thereof, and is penetrated by a discharge channel from its lower-end opening portion 13 to the discharge opening 12, with no member blocking the discharge channel. In addition, the opening portion 13 of the lower end of the cylindrical member 9 is formed into a partially tapered form narrowing toward the upside, and the lower end of the columnar member 10 is also provided in a tapered form narrowing downward, whereby as shown in FIG. 2, a section of the opening portion 13 is formed in a funnel shape, so that contents from the container body 2 easily flow into a gap. Without these tapered forms, an inflow resistance at the time of discharge is increased and discharging becomes difficult.

The inside diameter of the cylindrical member 9 is slightly greater than the outside diameter of the columnar member 10 so that, when the columnar member 10 is inserted in the cylindrical member 9, a circumferential surface gap 14 in the longitudinal direction and a plane gap 15 in the transverse direction are formed therebetween as shown in FIG. 2 and FIG. 3, at the side surface and upper end of the columnar member 10, respectively. For forming these gaps, as shown in FIG. 4, several (in the drawing, four) protruded threads 16 are formed in the lengthwise direction (on the page surface, up-and-down direction) of the side surface of the columnar member 10, and the height of these protruded threads 16 is designed so as to become the height of the gap. In addition, these protruded threads 16 are also extended to an upper end 18 of the cylindrical member 10 to form a gap between an interior lower end 17 of the cylindrical member 9 and the upper end 18 of the cylindrical member 10. As such, by providing protruded threads 16 of a fixed height, in terms of a cross-section (FIG. 5) along B-B in a condition where both have been fitted together, the circumferential surface gap 14 formed by both and the upper-end gap 15 shown in FIG. 2 are secured at fixed gap dimensions. Herein, as a matter of course, these protruded threads 16 may be replaced by protrusions. In addition, although the circumferential surface gap 14 is most simply constructed by a cylindrical body and a rod body as such, as a matter of course, it may be constructed by disposing so-called curved surfaces in parallel to each other.

This circumferential surface gap 14 is formed with such dimensions that, at a certain pressure or less, contents (liquid) to flow therethrough block the channel by its own viscosity or surface tension and cannot flow therethrough. That is, the lower the viscosity of the contents becomes, the narrower the dimension required for the gap, while on the other hand, if the viscosity is high, a wide gap is sufficient. And, the certain pressure herein mentioned means a greatness of force (negative pressure) which is produced in the container body, mainly after contents are pushed out by pressing the container 2 by hand, by a resilient restorative force, etc., of the container body 2, to draw back the contents into the container body. The plane gap 15 also serves as a landing where the contents which have flowed out of the circumferential surface gap 14 change the flow direction toward the discharge opening 12.

Here, in regard to a means for securing this gap dimension, this is not limited to a means by the above-described method. Namely, as shown in FIG. 6, protruded threads 16 may be provided on the inner surface of the cylindrical member 9, and as shown in FIG. 8, a fitting portion 20 having a diameter to match the inside diameter of the cylindrical member 9 may be provided, on the outer circumference of the columnar member 10, in the vicinity 19 of the upper end so as to be fitted. In the latter case, a notch portion 21 is provided at a desirable position of the fitting portion 20 to serve as a channel of the contents. In addition, as a matter of course, the fitting portion 20 may be provided at the cylindrical member 9-side or at the lower-end side of the columnar member 10. FIG. 7 and FIG. 9 are cross-sectional views along C-C and D-D of FIG. 6 and FIG. 8, respectively.

As in the above, the gap channel is constructed not only by a pair of surfaces, that is, the inner circumferential surface of a cylindrical member and the outer circumferential surface of a columnar member, but also, in some cases, by three or more faces if the circumferential shape is a polygon as shown in (a) and (b) of FIG. 11.

Here, in all of the following embodiments, as a method for forming gaps, any of the methods shown in the present embodiment or another method whereby the gap is uniformly and stably secured is applied.

For usage of the nozzle of the present invention formed as in the above and the present container provided with the same, description is given as in the following.

As shown in FIG. 10 by arrows, the contents are pushed out to the discharge opening side by an increase in the internal pressure as a result of pressing the outside of the container body 2 by hand or the like and enter a gap entrance 13 at the lower end of the nozzle 8 of the present invention. Although the contents cannot enter the circumferential surface gap 14 with a weak pressing force since the entrance is narrow, if a pressing force exceeding a certain pressing force is applied to the container body 2, the contents proceed into the circumferential surface gap 14, and flow to the discharge opening to be discharged.

Then, when the pressure onto the container body 2 is stopped after a desired amount of contents has been discharged, the container body 2 essentially intends to restore itself by its own resilience against the atmospheric pressure which the surface of the container body 2 receives, a negative pressure is produced in the container body, and as shown in FIG. 12, a force works on the contents in the plane gap 15 and discharge channel in a direction to draw the contents into the container. However, with this degree of negative pressure, since the contents are restricted from flowing by its own viscosity and surface tension and resistance in the channel and cannot flow against the resistance in the channel, the contents block the gaps and remain stagnated inside the channel. In greater detail, with the nozzle 8 of the present invention as a boundary, to the discharge opening 12, the atmospheric pressure is applied to its opening area, while inside the container body, a negative pressure is produced by a differential force between the atmospheric pressure which the surface of the container body 2 receives and restorative force of the container body 2. However, under normal pressure, since the nozzle 8 of the present invention balances both by functioning as a depressurizing orifice, movement of the contents owing to the pressure difference is restricted. Namely, the contents are never drawn back (never flow back) into the container body.

Accordingly, when discharging the contents again, the contents are immediately discharged from the discharge opening 12 by pressing the container body 2 at a force required for the contents being discharged against the resistance in the channel. Since no such process, as in the conventional container, to first discharge air drawn in the container body and then push out the contents exists, a container whose response to an external pressure is excellent can be provided.

Furthermore, since no air is drawn into the container body, this is preferable for contents which have an aversion toward oxidation.

In addition, at the front end of the discharge opening, although the contents can possibly be drawn in very slightly, contact between the contents and air can be reduced to virtually nothing without limitation by providing inside the cap 7 a seal to be made to contact with this discharge opening when the cap 7 is closed, or by providing a protrusion (unillustrated) fittable inside the discharge opening, so as to prevent the contents existing at the forefront from making contact with air.

Moreover, as for actions of these, since the nozzle 1 of the present invention has been constructed without using any movable components, malfunction never occurs and the function and performance are permanently maintained.

For a balance of ease in discharging the contents (ease in flowing) and the function for preventing a backflow (difficulty in flowing), as shown in FIG. 13, it is sufficient to appropriately adjust the respective gaps, which is to be a channel of the contents, namely, as to the cylindrical member 10, a dimension W1 of the circumferential surface gap 14 at its side surface, a dimension W2 of the plane gap 15 at the upper end, and an inside diameter W3 of the discharge opening 12.

### Embodiment 2

FIG. 14 through FIG. 17 show a second embodiment of an always-open-type discharge nozzle of the present invention and a container provided with the same.

FIG. 14 is an exploded view of a nozzle, FIG. 15 is a longitudinal sectional view showing the center of a main part in the vicinity of an opening portion, and as illustrated, for the present embodiment, a nozzle 8 of the present invention is inserted inside a cylindrical portion 3 of a container 1 of the present invention having a structure similar to that of Embodiment 1. The present embodiment is characterized in that circumferential surface gaps 14 and plane gaps 15 are provided in a multiple number, respectively.

In addition, similar to Embodiment 1, the nozzle 8 of the present invention is formed in a manner where a columnar member 10 is inserted inside a cylindrical member 9. FIG. 16 is a cross-sectional view along E-E of FIG. 15. As shown in FIG. 15, the cylindrical member 9 has a plane portion 11 provided at its upper end, and at its center portion, a discharge opening 12 is provided, and at its inside, as well, a tubular portion 22 almost the same as the discharge opening 12 is provided in a hanging condition, and a discharge channel penetrating from a lower-end opening portion 13 to the discharge opening 12 is not blocked by any member.

The columnar member 10 has, at its upper end, a concave portion 23 so that the tubular portion 22 of the cylindrical member 9 is inserted with a gap 14B at its side surface and with a gap 15B at its lower end. Since the bottom portion of the concave portion 23 has a spherical form, the gap 15B has a large space and, as shown in FIG. 17, an outflow from the gap 14B becomes smoother. However, at the time of backflow, since a channel from this large space to the gap 14B is suddenly narrowed, a depressurizing effect is provided to heighten a backflow preventing effect. The inside diameter of the cylindrical member 9 is slightly greater than the outside diameter of the columnar member 10 so that, when the columnar member 10 is inserted in the cylindrical member 9, a desirable circumferential surface gap 14 and a plane gap 15A are formed therebetween at the side surface and upper end of the columnar member 10, respectively. Furthermore, the inside diameter of the columnar member 10 is slightly greater than the outside diameter of the tubular portion 22 of the cylindrical member 9 so that, at the upper end of the columnar member 10 and the cylindrical member 9, the desirable gaps 14B and 15B are formed.

These circumferential surface gaps 14A and 14B are, similar to the method shown in Embodiment 1, formed with such dimensions that, at a certain pressure or less, contents (liquid) flowing therethrough block the channel by its own viscosity or surface tension and cannot flow therethrough.

In the present embodiment, the multiple gaps are provided by the tubular portion 22 and concave portion 23. With regard to the plane gaps 15, 15A serves as a U-turn portion of a flow from the circumferential surface gaps 14A to 14B, while the circumferential surface gap 15B serves as a landing to change the flow direction from the plane gap 14B to the discharge opening 12.

For usage of the nozzle of the present invention formed as in the above and the present container provided with the same, description is given as in the following.

As shown in FIG. 17 by arrows, the contents are pushed out to the discharge opening side by an increase in the internal pressure as a result of a pressure from the outside of the container body 2 and enter a gap entrance 13 at the lower end of the nozzle 8. Although the contents cannot enter the circumferential surface gap 14A with a weak pressing force since the entrance is narrow, if a pressing force exceeding a certain pressing force is applied to the container body, the contents proceed into the circumferential surface gap 14A, once flow into the plane gap 15A, make a U-turn there, flow in a direction opposite to its original flow direction, and further flow into the circumferential surface gap 14B. Then, the contents flow from the circumferential surface gap 14B, through the plane gap 15B, to the discharge opening 12 to be discharged.

Then, when the pressure onto the container body 2 is stopped after a desired amount of contents has been discharged, as a result of actions similar to those of Embodiment 1, the contents are never drawn back (never flow back) into the container body.

In the present embodiment, owing to the circumferential surface gaps 14 and plane gaps 15 provided in a multiple number and flow reversal, channel resistance becomes greater than that of Embodiment 1, and application for a liquid of a lower viscosity becomes possible. In addition, for a balance of ease in discharging the contents (ease in flowing) and the function for preventing a backflow (difficulty in flowing), similar to the above-described Embodiment 1, it is sufficient to appropriately adjust the respective gaps composing a flow channel of the contents.

FIG. 18 and FIG. 19 show a case where, in the above-described construction, the bottom portion of the upper-end concave portion 23 of the columnar member 10 is formed in a plane shape. Since the narrow channel is thereby wound at a right angle, a return flow channel resistance becomes greater, thereby improving the performance for preventing a backflow.

### Embodiment 3

FIG. 20 through FIG. 23 show a third embodiment of an always-open-type discharge nozzle of the present invention and a container provided with the same.

FIG. 20 is a longitudinal sectional view showing the center of a main part in the vicinity of an opening portion, and as illustrated, for the present embodiment, a nozzle 8 of the present invention is inserted inside a cylindrical portion 3 of a container 1 of the present invention constructed similarly to the above-described Embodiment 1. In the present embodiment, circumferential surface gaps 14 and plane gaps 15 are provided in a multiple number, respectively, and in comparison with the above-described Embodiment 2, the quantity of plane gaps 15 is greater by one.

The nozzle 8 of the present invention is formed in a manner where a cap-like member 24 is inserted inside a cylindrical member 9 and furthermore, inside the same, a cylindrical member 25 is inserted. FIG. 22 is a cross-sectional view along F-F of FIG. 20. As shown in FIG. 21, the cylindrical member 9 has a plane portion 11 provided at its upper end, and at its center portion, a discharge opening 12 is provided, and a discharge channel penetrating from a lower-end opening portion 13 to the discharge opening 12 is not blocked by any member.

The cap-like member 24 to be fitted with the cylindrical member 9 has a shape of a cylindrical form provided with a plane portion at the upper end, and this is, while orienting its opening portion downward, inserted inside the cylindrical member 9. Furthermore, the cylindrical member 25 to be fitted inside this cap-like member 24 displays an inverted T-shape in terms of a longitudinal section of a cylindrical portion 26 on whose lower end a flange 27 for blocking the lower-end opening portion 13 of the cylindrical member 9 is provided. The flange 27 is provided with an opening 28 at its center, where the cylindrical portion 26 penetrates. And, for the respective members 9, 24, and 25, dimensions are determined by a method the same as that of the above-described Embodiment 1 so that gaps are individually formed, and these are inserted and integrated. And, as shown in FIG. 20, as gaps in the circumferential direction, two gaps of 14A and 14B are formed, and as plane gaps in the transverse direction, three gaps of 15A, 15B and 15C are formed.

For usage of the nozzle of the present invention formed as in the above and the present container provided with the same, description is given as in the following.

As shown in FIG. 23 by arrows, the contents are pushed out to the discharge opening side by an increase in the internal pressure as a result of a pressure from the outside of the container body 2 and enter an entrance (opening) 28 at the lower end of this cylindrical member 25. Although an internal channel of the cylindrical portion 26 of the cylindrical member 25 to be the entrance is relatively thick and the contents easily enter therein, the contents cannot enter the circumferential surface gap 14A with a weak pressing force since the contents are abruptly forced to change direction at the plane gap 15A and an entrance of the circumferential surface gap 14A is narrow. However, if a pressing force exceeding a certain pressing force is applied to the container body 2, the contents make a U-turn at the plane gap 15A, flow in a direction opposite the original direction, proceed into the circumferential surface gap 14A, flow to the plane gap 15B, and further make a U-turn there and flow into the circumferential gap 14B, and flow via the plane gap 15C to the discharge opening 12 to be discharged.

Then, when the pressure onto the container body 2 is stopped after a desired amount of contents has been discharged, a shown in FIG. 24, as a result of actions similar to those of Embodiment 1, the contents and outer air are never drawn back (never flow back) into the container body.

In the present embodiment, in addition to the circumferential surface gaps 14 and plane gaps 15 provided in a multiple number, owing to the two-time sharp reversal, channel resistance becomes greater than that of Embodiment 2, therefore, application for a liquid of a lower viscosity becomes possible. In addition, for a balance of ease in discharging the contents (ease in flowing) and the function for preventing a backflow (difficulty in flowing), it is sufficient to appropriately adjust the respective gaps 14 and 15 composing a flow channel of the contents as shown in FIG. 25.

### Embodiment 4

FIG. 26 through FIG. 35 show a fourth embodiment of an always-open-type discharge nozzle of the present invention and a container provided with the same.

FIG. 26 shows an overall perspective view in a condition where a cap has been removed, and FIG. 27 is a longitudinal sectional view showing the center of a main part in the vicinity of an opening portion of a container of the present invention. In FIG. 26 and FIG. 27, similar to the above-described Embodiment 1, a container 1 of the present invention has a cylindrical portion 3 integrally provided on an upper portion of a container body 2, and at its inside, a nozzle 8 of the present invention is provided, and on the outer circumference of the cylindrical portion 3, a male screw 6 is provided, with which a nozzle cap 29 provided with at its center a discharge opening 12 in a protruding condition is screwed (illustrated by broken lines in FIG. 27), whereby a flange 32 of the nozzle 8 is sandwiched and fixed to the upper end of the cylindrical body 3. A male screw 6 is provided on the outer circumference of the front-end discharge opening 12 of the nozzle cap 29, and the cap 7 is screwed by this screw 6. In this embodiment, as well, the container body 2 is provided as a tube container.

The nozzle 8 of the present invention is constructed in such a manner where a columnar member 30 and a cylindrical member 3 are inserted inside a cylindrical portion 3. As shown in FIG. 28, on the columnar member 30 provided with the flange 32 at its upper end, a thread groove 33 is provided in the circumferential direction directly under the flange 32, and at the center of the flange 32, a discharge channel 34 is provided so as to have a depth the same as this thread groove position, and furthermore, channels 35 communicating the bottom portion of this discharge channel 34 and the bottom portion of the thread groove 33 are radially provided. Although these channels 35 are tubular channels whose section is circular in FIG. 28, these may have any sectional shape as long as the discharge channel 34 and thread groove 33 are communicated. Still furthermore, the lower side of the thread groove 33 is provided as a straight portion 36 toward the lower end.

The cylindrical member 31 is an almost simple tubular body, and its upper end is constructed so that the inside diameter is fitted with the outside diameter of the columnar member 30 between the flange 32 and thread groove 33. And, a circumferential surface gap 14 is formed between the inner circumferential surface of the cylindrical member 31 and outer circumferential surface of the straight portion 36 of the columnar member 30 by a method the same as that of the above-described Embodiment 1.

FIG. 29 and FIG. 30 are cross-sectional views along G-G and along H-H of FIG. 27, respectively.

For usage of the nozzle of the present invention formed as in the above and the present container provided with the same, description is given as in the following.

As shown in FIG. 31 by arrows, the contents are pushed out to the discharge opening side by an increase in the internal pressure as a result of a pressure from the outside of the container body 2 and enter, at the lower end of the nozzle 8, an entrance of the circumferential surface gap 14 from an opening portion 37 of the lower end of the cylindrical member 31. Although the contents cannot enter the circumferential surface gap 14 with a weak pressing force since the entrance is narrow, if a pressing force exceeding a certain pressing force is applied to the container body 2, the contents proceed into the circumferential surface gap 14, once flow to the thread groove 33, change the flow direction at a right angle there, flow out into the discharge channel 34 through the channel 35, and flow to the discharge opening 12 of the nozzle cap 29 to be discharged.

Then, when the pressure onto the container body 2 is stopped after a desired amount of contents has been discharged, the contents are nearly drawn back into the container as shown in FIG. 32. However, owing to actions similar to those of the above-described Embodiment 1, the contents are never drawn back (never flow back) into the container body.

For a balance of ease in discharging the contents (ease in flowing) and the function for preventing a backflow (difficulty in flowing), as shown in FIG. 33, it is sufficient to appropriately adjust the respective gaps composing a flow channel of the contents, namely, in the cylindrical member 30, a dimension W1 of the circumferential surface gap 14 at its side surface, a dimension W2 of the transverse channel 35, an inside diameter W3 of the discharge channel 34, and an inside diameter W4 of the discharge opening 12.

FIG. 34 shows a case where, in the above-described construction, a bottom portion 38 is provided at the lower end of the cylindrical member 31, and the opening portion 37 is provided as a hole of a smaller diameter, so that a gap 15 in the transverse direction is also formed between the lower end of the columnar member 30 and inside of the bottom surface of the cylindrical member 31. Furthermore, FIG. 35 shows, in this case, a case where a concave portion 39 is provided at the lower end of the cylindrical member 30 so that inflow from the opening portion 37 and a direction change in the transverse direction become smoother.

### Embodiment 5

FIG. 36 through FIG. 42 show a fifth embodiment of an always-open-type discharge nozzle of the present invention and a container provided with the same.

FIG. 36 is a longitudinal sectional view showing the center of a main part in the vicinity of an opening portion, and as illustrated, for the present embodiment, a nozzle 8 of the present invention is inserted inside a cylindrical portion 3 of a container 1 of the present invention constructed similarly to the above-described Embodiment 1. Although this is almost the same in the gap construction as Embodiment 1, an inlet of the contents into a nozzle 8 of the present invention is arranged at a position closer to the discharge opening 12.

The nozzle 8 of the present invention shown in FIG. 37 is constructed in such a manner as shown in FIG. 38 where a cylindrical member 31 is inserted in a cap-like member 41 provided with an opening portion 40 at its upside. As shown in FIG. 38, the cup-like member 41 has a flange 32 provided at its upper end, and its circumferential portion is further erected upward to form a step 42. The cylindrical member 31 also has a flange 32 at its upper end, and at a position somewhat lower than this flange 32, a thread groove 33 in the circumferential direction is formed, and furthermore, at the lower end as well, a step 42 is provided at the circumference. The flange 32 of the cylindrical member 31 has, in terms of its diameter, a dimension to match the inside diameter of the step 42 of the flange 32 of the cup-like member 41, and the flange 32 of the cylindrical member 31 is fitted and integrated with the step 42 of the cup-like member 41. In the cup-like member 41, channels to be communicated with the inside are provided at a position under the flange 32, and located to match with the thread groove 33 of the cylindrical member 31 inserted inside.

A straight part 43 under the thread groove of the cylindrical member 31 has a diameter somewhat smaller than the inside diameter of a cylindrical portion 44 of the cup-like member, and as shown in FIG. 36, between both, a circumferential surface gap 14 is formed, and between the lower end of the cylindrical member 31 and inner bottom of the cap-like member 41, a plane gap 15 is formed, by a method the same as that of the above-described Embodiment 1.

FIG. 39 is a sectional view along J-J of FIG. 37.

For usage of the present container provided with the nozzle of the present invention formed as in the above, description is given as in the following.

As shown in FIG. 40 by arrows, the contents are pushed out to the discharge opening side by an increase in the internal pressure as a result of a pressure from the outside of the container body 2, flow inside a gap between the cylindrical portion 3 and the nozzle 8 of the present invention in a direction toward a container opening portion, and enter the entrance of the channel 35. The contents which have entered through the channel 35 enter a space formed in the back by the thread groove 33, and change, while once stagnating, the flow direction to a direction toward the circumferential surface gap 14. Although the contents cannot enter the circumferential surface gap 14 with a weak pressing force since the entrance of the circumferential surface gap 14 is narrow, if a pressing force exceeding a certain pressing force is applied to the container body 2, the contents change direction in the thread groove, flow in a direction opposite to its original flow direction, and enter a space formed by the step 42 provided at the lower end of the cylindrical member 31. This space is, similar to the thread groove 33, a so-called landing to make the contents easy to change direction, and the contents are once herein accumulated and flow to the plane gap 15. Then, the contents pass, via the plane gap 15, the discharge channel 34 inside the tubular member 31 and flow to the discharge opening 12 to be discharged.

Then, when the pressure onto the container body 2 is stopped after a desired amount of contents has been discharged, a force to draw back the contents into the container body works on the contents stagnating in the channel as shown in FIG. 41. However, owing to actions similar to those of Embodiment 1, the contents and outer air are never drawn back (never flow back) into the container body.

For a balance of ease in discharging the contents (ease in flowing) and the function for preventing a backflow (difficulty in flowing), as shown in FIG. 42, it is sufficient to appropriately adjust the respective gaps composing a flow channel of the contents, namely, in the cylindrical member 31, a dimension W1 of the circumferential surface gap 14 at its side surface, a dimension W2 of the plane gap 15 of a lower end portion, an inside diameter W3 of the discharge channel 34, and an inside diameter W4 of the discharge opening 12.

FIG. 43 and FIG. 44 show variations of the shapes of the thread groove 33 of the cylindrical member 31 and the step 42 of the lower end portion, respectively. As such, in order to form a certain space at a desirable position of the gap channel as a so-called landing for a direction change of flow, the shapes of the thread groove 33 and step 42 are not limited to a rectangular form.

### Embodiment 6

FIG. 45 through FIG. 51 show a sixth embodiment of a nozzle of the present invention and a container provided with the same, which can be mentioned as a simple type of the above-described Embodiment 4.

FIG. 45 is a longitudinal sectional view showing the center of a main part in the vicinity of an opening portion.

In the present embodiment, a nozzle 8 of the present invention is constructed in such a manner where a columnar member 30 is directly inserted inside a cylindrical portion 3 of a container 1 of the present invention constructed similarly to the above-described Embodiment 1. As shown in FIG. 45 and FIG. 46, on a columnar member 30 provided with a flange 32 at its upper end, a thread groove 33 is provided in the circumferential direction directly under the flange 32, and at the center of the flange 32, a discharge channel 34 is provided so as to have a depth the same as this thread groove position, and furthermore, channels 35 communicating the bottom portion of this discharge channel 34 and the bottom portion of the thread groove 33 are radially provided. Although these channels 35 are tubular channels whose section is circular in the drawings, these may have any sectional shape as long as the discharge channel 34 and thread groove 33 are communicated. Still furthermore, the lower side of the thread groove 33 is provided as a straight portion 36 toward the lower end.

A cylindrical portion 3 is formed parallel to a straight portion 36 of the columnar member 30, and this forms, between its inside diameter and the straight portion 36 of the columnar member 30, a circumferential surface gap 14 by a method the same as that of the above-described Embodiment 1. In the present embodiment, since the columnar member 30 is directly fitted to the inside of the cylindrical portion 3, for securing accuracy and uniformity of the gap, an appropriate accuracy (parallelism) is required in forming the inside of the cylindrical portion 3.

Then, on the cylindrical portion 3, a male screw 6 is provided, with which a nozzle cap 29 provided with at its center a discharge opening 12 in a protruding condition is screwed (illustrated by broken lines in FIG. 45), whereby the flange 32 of the columnar member 30 is sandwiched and fixed to the upper end of the cylindrical body.

FIG. 47 and FIG. 48 are cross-sectional views along K-K and along L-L of FIG. 45, respectively.

For usage of the nozzle of the present invention formed as in the above and the present container provided with the same, description is given as in the following.

As shown in FIG. 49 by arrows, the contents are pushed out to the discharge opening side by an increase in the internal pressure as a result of a pressure from the outside of the container body 2 and enter an entrance of the circumferential surface gap 14 of the nozzle 8 of the present invention. Although the contents cannot enter the circumferential surface gap 14 with a weak pressing force since the entrance is narrow, if a pressing force exceeding a certain pressing force is applied to the container body, the contents proceed into the circumferential surface gap 14, once flow to the thread groove 33, change the flow direction at a right angle there, flow out into the discharge channel 34 through the channel 35, and flow to the discharge opening 12 of the nozzle cap 29 to be discharged.

Then, when the pressure onto the container body 2 is stopped after a desired amount of contents has been discharged, the contents stagnating in the channel are nearly drawn back into the container as shown in FIG. 50. However, owing to actions similar to those of the above-described Embodiment 1, the contents and outer air are never drawn back (never flow back) into the container body.

For a balance of ease in discharging the contents (ease in flowing) and the function for preventing a backflow (difficulty in flowing), as shown in FIG. 51, it is sufficient to appropriately adjust the respective gaps composing a flow channel of the contents, namely, in the cylindrical member 30, a dimension W1 of the circumferential surface gap 14 at its side surface, a dimension W2 of the transverse channel 35, an inside diameter W3 of the discharge channel 34, and an inside diameter W4 of the discharge opening 12.

### Embodiment 7

FIG. 52 through FIG. 58 show a seventh embodiment of a nozzle of the present invention and a container provided with the same.

In the present embodiment, a nozzle 8 of the present invention is formed in a manner where a nozzle piece 46 is directly fitted inside a cylindrical portion 3 of a container 1 of the present invention constructed similarly to the above-described Embodiment 1. This nozzle piece 46 is formed in an almost H shape, and on the outer circumference, two thread grooves 33A and 33B are provided one above the other in parallel in the circumferential direction, and furthermore, at upper and lower ends in the height direction, a discharge channel 34 and an entrance channel 47 are formed, respectively. And, as shown in FIG. 54, which is across-sectional view along N-N of FIG. 52, the discharge channel 34 and entrance channel 47 are communicated with the thread groove 33A by channels 35A provided in the diametrical direction with respect to both channels. With regard to a relationship between channels 35B and the thread groove 33B, these are also similarly communicated by channels 35B shown in FIG. 53.

As shown in FIG. 53, the outer circumferential surface of the nozzle piece 46 is provided with two thread grooves 33A and 33B, so as to have such a shape that three protruded threads are formed by being divided by the two thread grooves 33A and 33B. And, the uppermost portion of the three protruded threads forms a flange 32, and a step 42 exists between the flange 32 and the upper thread groove 33B. The middle protruded thread portion has, as a straight portion 36, a slightly smaller diameter than that of the upper and lower protruded threads. In addition, the lowermost protruded thread 48 has such a diameter as to match the inside diameter of the cylindrical portion 3, which is the same as the step 42. When this nozzle piece 46 is attached to the cylindrical portion 3 of the container body 2, the nozzle piece 46 is inserted in the cylindrical portion 3 until the flange 32 is made into contact with an end face 45 of the cylindrical portion 3, and the step 42 and the lowermost protruded thread 48 are fitted with the inside diameter of the cylindrical portion 3. Thereby, a circumferential surface gap 14 is produced between the center straight portion 36 and the inside diameter of the cylindrical portion 3, and the two upper and lower thread grooves 33A and 33B are communicated by this circumferential surface gap 14. For forming this circumferential surface gap 14, the method disclosed in Embodiment 1 is applied. In addition, similar to the above-described Embodiment 6, since the nozzle piece 46 is directly fitted to the inside of the cylindrical portion 3, for securing accuracy and uniformity of the gap, an appropriate accuracy (parallelism) is required in forming the inside of the cylindrical portion 3.

And, on the outer circumference of the cylindrical portion 3, a male screw 6 is provided, with which a nozzle cap 29 provided wit at its center a discharge opening 12 in a protruding condition is screwed, whereby the flange 32 of the nozzle piece 46 is sandwiched and fixed to the upper end 45 of the cylindrical body.

FIG. 54 and FIG. 55 are cross-sectional views along M-M and along N-N of FIG. 52, respectively.

For usage of the nozzle of the present invention formed as in the above and the present container provided with the same, description is given as in the following.

As shown in FIG. 56 by arrows, the contents are pushed out to the discharge opening side by an increase in the internal pressure as a result of a pressure from the outside of the container body 2 and enter an entrance of an entrance channel 47 of this nozzle piece 46. When the contents come to the end, contents change direction toward an entrance of the channel 35A in the transverse direction. The contents pass through the channel 35A, enter the thread groove 33A, and change, while once stagnating, direction toward the upside. Although the contents cannot enter the gap 14 with a weak pressing force since the entrance of the circumferential surface gap 14 is narrow, if a pressing force exceeding a certain pressing force is applied to the container body 2, the contents proceed into the circumferential surface gap 14, once flow to the thread groove 33B, change the flow direction at a right angle there, flow out into the discharge channel 34 through the channel 35B, and flow to the discharge opening 12 of the nozzle cap 29 to be discharged.

Then, when the pressure onto the container body 2 is stopped after a desired amount of contents has been discharged, a force to draw back the contents into the container works on the contents stagnating in the channel as shown in FIG. 57. However, owing to actions similar to those of the above-described Embodiment 1, the contents and outer air are never drawn back (never flow back) into the container body.

For a balance of ease in discharging the contents (ease in flowing) and the function for preventing a backflow (difficulty in flowing), as shown in FIG. 58, it is sufficient to appropriately adjust the respective gaps composing a flow channel of the contents, namely, a diameter W1 of the entrance channel, a diameter W2 of the transverse channel 35A, a dimension W3 of the circumferential surface gap 14, a diameter W4 of the transverse channel 35B, an inside diameter W5 of the discharge channel 34, and an inside diameter W6 of the discharge opening 12.

FIG. 59 and FIG. 60 show variations of the sectional shapes of the thread grooves 33A and 33B of the nozzle piece 46, respectively. As such, in order to form a certain space at a desirable position of the gap channel as a so-called landing for a direction change of flow, the shapes of the thread grooves are not limited to a rectangular form.

### Embodiment 8

FIG. 61 through FIG. 70 show an eighth embodiment of an always-open-type discharge nozzle of the present invention and a container provided with the same.

FIG. 61 is a longitudinal sectional view showing the center of a main part in the vicinity of an opening portion of a container of the present invention.

As shown in FIG. 61, a nozzle 8 of the present invention is inserted inside a cylindrical portion 3 of a container 1 of the present invention constructed similarly to the above-described Embodiment 1. The nozzle 8 of the present invention is constructed in such a manner where a gap piece 49 having a plurality of plane gaps 15 provided in proximity is inserted inside a tubular member 9. As shown in FIG. 62, the cylindrical member 9 has a plane portion 11 provided at its upper end and a discharge opening 12 provided at its center portion, and is penetrated from a lower-end opening portion 13 to the discharge opening 12. In addition, the opening portion 13 of the lower end of the cylindrical member 9 has a partially tapered form narrowing toward the upside, so that contents from the container body 2 easily flow into the plane gaps 15.

The inside diameter of the cylindrical member 9 and the outside diameter of the gap piece 49 have dimensions to fit with each other, and the outside diameter of the cylindrical member 9 has a dimension to fit with the inside diameter of the cylindrical member 3. Here, for inserting this gap piece 49 inside the cylindrical portion, it is sufficient to, before welding the lower end of the container body 2, insert the same from the lower-end opening and then weld the lower end. FIG. 63 is a cross-sectional view along P-P of FIG. 61.

The gap piece 49 is, as shown in FIG. 62 and FIG. 64 through FIG. 66, a cylindrical member inside which a plurality of plane gaps 15 have been provided in proximity, and its upper end forms a concave portion 50 hollowed at a desirable dimension to secure a gap from the inner lower-end face of the cylindrical member 9. In addition, in order to prevent the contents passed through the plane gaps 15 of a center portion from being discharged from the discharge opening 12 at an unchanged rate, an obstacle plate 51 almost the same in the diameter as the discharge opening 12 is provided at the center of the concave portion 50.

FIG. 64 and FIG. 65 are a plan view and a bottom view of the gap piece 43, respectively, and FIG. 66 is a cross-sectional view along R-R.

Similar to the above-described respective embodiments, these gaps 14 are formed at dimensions according to the viscosity of the contents.

For usage of the nozzle of the present invention formed as in the above and the present container provided with the same, description is given as in the following.

As shown in FIG. 67 by arrows, the contents are pushed out to the discharge opening side by an increase in the internal pressure as a result of a pressure from the outside of the container body 2 and enter the gap entrance 13 at the lower end of the nozzle 8. Although the contents immediately reach an entrance of the plane gap 15, the contents cannot enter the plane gap 15 with a weak pressing force since the entrance is narrow. However, if a pressing force exceeding a certain pressing force is applied to the container body 2, the contents proceed into the plane gap 15 and flow to the discharge opening 12 to be discharged. FIG. 68 is a sectional view along Q-Q of FIG. 61, and at this time, the contents which have proceeded into the plane gaps 15 in the vicinity of the center cannot, as shown in FIG. 68, linearly flow toward the discharge opening 12 as the contents hit the rear surface of the obstacle plate 51, make a detour to avoid the obstacle plate 51, and flow to the discharge opening 12.

Then, when the pressure onto the container body 2 is stopped after a desired amount of contents has been discharged, a force to draw back the contents into the container body works on the contents stagnating in the channel as shown in FIG. 69, however, owing to actions similar to those of the above-described Embodiment 1, the contents and outer air are never drawn back (never flow back) into the container body.

For a balance of ease in discharging the contents (ease in flowing) and the function for preventing a backflow (difficulty in flowing), as shown in FIG. 70, it is sufficient to appropriately adjust the respective gaps composing a flow channel of the contents, namely, a dimension W1 of the plane gap 15 and an inside diameter W2 of the discharge opening 12.

### Embodiment 9

FIG. 71 through FIG. 77 show a ninth embodiment of an always-open-type discharge nozzle of the present invention and a container provided with the same.

FIG. 71 is a longitudinal sectional view showing the center of a main part in the vicinity of an opening portion of the present invention.

As shown in FIG. 71, a nozzle 8 of the present invention is inserted inside a cylindrical portion 3 of a container 1 of the present invention constructed similarly to the above-described Embodiment 1. The nozzle 8 of the present invention is constructed in such a manner where two upper and lower pieces provided with mutually spherical concave and convex portions inserted into each other. As shown in FIG. 71 and FIG. 72, the upper piece 52 has a discharge opening 12 provided at its center portion in a protruding condition and is penetrated up and down. In addition, at its lower end, a spherical concave portion 52 is formed, and at a lower portion of the outer circumference, a step 42 with which the lower piece is fitted is formed. Since the lower piece 53 is formed in a shallow cup shape, at its center portion, a ball-like protrusion 56 matching a spherical concave portion 52 of the upper piece 53 with a desirable spherical gap 14 is formed. FIG. 73 and FIG. 74 are cross-sectional views along S-S and T-T of FIG. 71, respectively.

In addition, around the ball-like protrusion 56, a desirable number of channels 35 communicated with a lower surface 55 of the lower piece 53 are provided. These channels 35 do not necessarily have a circular section and can be any shape as long as these are opened so that the contents flow from the inside of the container body to the spherical gap 14 formed by the spherical concave portion 54 and spherical protrusion 56. Here, in the present embodiment as well, for forming this spherical gap 14, the method disclosed in Embodiment 1 is applied. In addition, for inserting the nozzle 8 of the present invention inside the cylindrical portion, similar to the gap piece 49 of the above-described Embodiment 8, it is sufficient to, before welding the lower end of the container body 2, insert the same from the lower-end opening and then weld the lower end.

For usage of the nozzle of the present invention formed as in the above and the present container provided with the same, description is given as in the following.

As shown in FIG. 75 by arrows, the contents are pushed out to the discharge opening side by an increase in the internal pressure as a result of a pressure from the outside of the container body 2 and enter an entrance of the channel 35 at the lower end of this nozzle 8. Although the contents passed through the channel 35 immediately reach an entrance of the spherical gap 14, the contents cannot enter the spherical gap 14 with a weak pressing force since the entrance is narrow, however, if a pressing force exceeding a certain pressing force is applied to the container body 2, the contents proceed into the spherical gap 14 and flow to a discharge opening 12 through a discharge channel 34 to be discharged.

Then, when the pressure onto the container body 2 is stopped after a desired amount of contents has been discharged, a force to draw back the contents into the container body works on the contents stagnating in the channel as shown in FIG. 76. However, owing to actions similar to those of the above-described Embodiment 1, the contents and outer air are never drawn back (never flow back) into the container body.

For a balance of ease in discharging the contents (ease in flowing) and the function for preventing a backflow (difficulty in flowing), as shown in FIG. 77, it is sufficient to appropriately adjust the respective gaps composing a flow channel of the contents, namely, an inside diameter dimension W1 of the channel 35, a dimension W2 of the gap 14, and an inside diameter W3 of the discharge opening 12 (discharge channel 34.)

### Embodiment 10

FIG. 78 through FIG. 87 show a tenth embodiment of an always-open-type discharge nozzle of the present invention and a container provided with the same.

In the present embodiment, in contrast to the above-described first embodiment, which has formed the liquid channel by a circumferential surface gap 14, the liquid channel is composed of minute channels. Namely, as shown in FIG. 78, which is a sectional view along A-A of FIG. 1, and FIG. 79, innumerable thread groves 60 are formed in the longitudinal direction (as shown in FIG. 79, on the page surface, in the up-and-down direction) of the side surface of a columnar member 10, and the respective thread grooves 60 form thin channels (hereinafter, minute channels) 61 between the same and the inner surface of a cylindrical member 9. In addition, as shown in FIG. 2, similar to Embodiment 1, a plane gap 15 is formed between an inner lower-end surface 16 of the cylindrical member 9 and an upper-end surface 17 of the columnar member 10. In order to secure this plane gap 15 uniformly, it is preferable to provide protrusions 62 having a height dimension of the gap as shown in FIG. 79.

These minute channels 61 are each formed with such dimensions that, at a certain pressure or less, contents (liquid) flowing therethrough block the channel by its own viscosity or surface tension and cannot flow therethrough. That is, the lower the viscosity of the contents becomes, the narrower the dimension required for the channel, while on the other hand, if the viscosity is high, a wide channel is sufficient. That is, the size of a cross-sectional area of the channel is determined, in terms of FIG. 78, by the width and depth of the thread groove 60. And, the certain pressure herein mentioned means a greatness of a force (negative pressure) which is produced, mainly after contents are pushed out by pressing the container 2, by a resilient restorative force, etc., of the container body 2 in the container body to draw back the contents into the container body. For the plane gap 15, if a small dimension is secured for this, a channel at the corners of the upper end of the columnar member is curved at a right angle to create a further flow channel resistance. If there is an aversion toward such a resistance, it is preferable to chamfer the corner portions of the upper end of the columnar member 10. On the other hand, if a large dimension is secured for this, since it serves as a landing when the contents which have flowed out of the minute channels 61 change flow direction toward the discharge opening, it becomes easy to discharge the contents.

Here, in regard to a forming method of these minute channels 61, the method is not limited to the above-described method. Namely, as shown in FIG. 80, the innumerable minute thread grooves 60 of FIG. 79 may be replaced by protruded threads 63, or as shown in FIG. 82, these may be provided as thread grooves 60 or protruded threads 63 formed in a mesh form. These are formed as so-called knurlings 64 by, in addition to injection molding, rolling, etc. In FIG. 82, illustration of most knurlings 64 is omitted. FIG. 81 and FIG. 83 are cross-sectional views along U-U and V-V of FIG. 80 and FIG. 82, respectively. Furthermore, as shown in FIG. 84, a construction of these thread grooves 60, protruded threads 63 or the like may be provided on the inner surface of the cylindrical member 9. FIG. 85 is a cross-sectional view along W-W. In addition, as such, for forming the minute channels 61, as shown in FIG. 86 and FIG. 87, the thread grooves 60 or protruded threads 63 may be provided on either the outer circumference of the columnar member 10 (FIG. 86(a) and FIG. 87(a)) or the inner circumference of the cylindrical member 9 (FIG. 86(b) and FIG. 87(b)). Namely, the minute channels 61 form channels whose cross-section is minute as a result of either, as shown in FIG. 86, being formed by the minute thread grooves 60 and a plane surface with which juxtaposed ridges thereof are made to contact or, as shown in FIG. 87, being formed by a plane surface with which the juxtaposed protruded threads 63 are made to contact. And, moreover, as a matter of course, the cross-section of the channel may be an almost semicircular form as shown in FIG. 86, an almost triangular form as shown in FIG. 87, or a rectangular form (unillustrated.)

Here, in all of the following embodiments, as a method for forming minute channels, any of the methods shown in the present embodiment or another method whereby the minute channels are uniformly and stably secured is applied.

For usage of the nozzle of the present invention formed as in the above and the present container provided with the same, description is given as in the following.

As shown in FIG. 10 of incorporated Embodiment 1 by arrows, the contents are pushed out to the discharge opening side by an increase in the internal pressure as a result of a pressure from the outside of the container body 2 and enter a minute channel entrance (opening) 13 at the lower end of the nozzle 8 of the present invention. Although the contents cannot enter the minute channel 61 (14 in FIG. 10) with a weak pressing force since the entrance is narrow, if a pressing force exceeding a certain pressing force is applied to the container body 2, the contents proceed into the minute channel 61 and flow to a discharge opening 12 to be discharged.

Then, when the pressure onto the container body 2 is stopped after a desired amount of contents has been discharged, since the container body 2 intends to restore itself by its own resilience against the atmospheric pressure which the surface of the container body 2 receives, a negative pressure is produced in the container body, and as shown in FIG. 12, a force works on the contents in the minute channel 61 and discharge channel in a direction to draw the contents into the container body.

For a balance of ease in discharging the contents (ease in flowing) and the function for preventing a backflow (difficulty in flowing), as shown in FIG. 13, it is sufficient to appropriately adjust the respective dimensions of a flow channel of the contents, namely, in the cylindrical member 10, a dimension W1 of the minute channel 61 (14 in FIG. 13) at its side surface, a dimension W2 of the gap 15 at the upper end, and an inside diameter W3 of the discharge opening 12.

### Embodiment 11

FIG. 88 is a cross-sectional view along E-E of FIG. 15 of the above-described Embodiment 2, showing an eleventh embodiment of an always-open-type discharge nozzle of the present invention.

Similar to the above-described Embodiment 10, in the present embodiment as well, the circumferential surface gaps 14 of the above-described Embodiment 2 are replaced by minute channels 61. Namely, the present embodiment is characterized in that minute channels 61 and plane gaps 15 are provided in a multiple number, respectively. The construction and operations and effects are the same as those of Embodiment 2 except for that the circumferential surface gaps 14 of Embodiment 2 are replaced by the minute channels 61. Therefore, for the construction of the minute channels 61, the description of the above-described Embodiment 10 is incorporated, and the description of Embodiment 2 is incorporated by rephrasing therein the circumferential surface gaps 14 as minute channels 61.

### Embodiment 12

FIG. 89 and FIG. 90 show a twelfth embodiment of an always-open-type discharge nozzle of the present invention. FIG. 89 is an exploded view of the nozzle, and FIG. 90 is a cross-sectional view along F-F of FIG. 20 of Embodiment 3.

Similar to the above-described Embodiment 10, in the present embodiment as well, the circumferential surface gaps 14 of the above-described Embodiment 3 are replaced by minute channels 61, and the construction and operations and effects are the same as those of Embodiment 3 except for that the circumferential surface gaps 14 of Embodiment 3 are replaced by the minute channels 61. Therefore, for the construction of the minute channels 61, the description of the above-described embodiment 10 is incorporated, and the description of Embodiment 3 is incorporated by rephrasing therein the circumferential surface gaps 14 as minute channels 61.

### Embodiment 13

FIG. 91 and FIG. 92 show a thirteenth embodiment of an always-open-type discharge nozzle of the present invention. FIG. 91 is an exploded view of the nozzle, and FIG. 92 is across-sectional view along H-H of FIG. 24 of Embodiment 4.

Similar to the above-described Embodiment 10, in the present embodiment as well, the circumferential surface gap 14 of the above-described Embodiment 4 is replaced by minute channels 61, and the construction and operations and effects are the same as those of Embodiment 4 except for that the circumferential surface gap 14 of Embodiment 4 is replaced by the minute channels 61. Therefore, for the construction of the minute channels 61, the description of the above-described Embodiment 10 is incorporated, and the description of Embodiment 4 is incorporated by rephrasing therein the circumferential surface gap 14 as minute channels 61.

### Embodiment 14

FIG. 93 and FIG. 94 show a fourteenth embodiment of an always-open-type discharge nozzle of the present invention. FIG. 93 is an exploded view of the nozzle, and FIG. 94 is a cross-sectional view along J-J of FIG. 37 of Embodiment 5.

Similar to the above-described Embodiment 10, in the present embodiment as well, the circumferential surface gap 14 of the above-described Embodiment 5 is replaced by minute channels 61, and the construction and operations and effects are the same as those of Embodiment 5 except for that the circumferential surface gap 14 of Embodiment 5 is replaced by the minute channels 61. Therefore, for the construction of the minute channels 61, the description of the above-described Embodiment 10 is incorporated, and the description of Embodiment 5 is incorporated by rephrasing therein the circumferential surface gap 14 as minute channels 61.

### Embodiment 15

FIG. 95 through FIG. 97 show a fifteenth embodiment of an always-open-type discharge nozzle of the present invention. FIG. 95 is an exploded view of the nozzle, and FIG. 96 and FIG. 97 are cross-sectional views along K-K and along L-L of FIG. 42 of Embodiment 6, respectively.

Similar to the above-described Embodiment 10, in the present embodiment as well, the circumferential surface gap 14 of the above-described Embodiment 6 is replaced by minute channels 61, and the construction and operations and effects are the same as those of Embodiment 6 except for that the circumferential surface gap 14 of Embodiment 6 is replaced by the minute channels 61. Therefore, for the construction of the minute channels 61, the description of the above-described Embodiment 10 is incorporated, and the description of Embodiment 6 is incorporated by rephrasing therein the circumferential surface gap 14 as minute channels 61.

### Embodiment 16

FIG. 98 through FIG. 100 show a sixteenth embodiment of an always-open-type discharge nozzle of the present invention. FIG. 98 is an exploded view of the nozzle, and FIG. 99 and FIG. 100 are cross-sectional views along M-M and along N-N of FIG. 52 of Embodiment 7, respectively.

Similar to the above-described Embodiment 10, in the present embodiment as well, the circumferential surface gap 14 of the above-described Embodiment 7 is replaced by minute channels 61, and the construction and operations and effects are the same as those of Embodiment 7 except for that the circumferential surface gap 14 of Embodiment 7 is replaced by the minute channels 61. Therefore, for the construction of the minute channels 61, the description of the above-described Embodiment 10 is incorporated, and the description of Embodiment 7 is incorporated by rephrasing therein the circumferential surface gap 14 as minute channels 61.

### Embodiment 17

FIG. 101 through FIG. 106 show a seventeenth embodiment of an always-open-type discharge nozzle of the present invention. And, an overall view of a container provided with the same nozzle is the same as FIG. 26.

FIG. 101 is a longitudinal sectional view showing the center of a main part in the vicinity of an opening portion of a container of the present invention.

A container body 2 and a cylindrical portion 3 are integrally formed from polyethylene or a composite material by an ordinary method. Inside the cylindrical portion 3, a nozzle 8 of the present invention is inserted. The nozzle 8 of the present invention is constructed in such a manner where a lower piece 66 is inserted inside an upper piece 65. FIG. 102 are cross-sectional views along X-X of FIG. 101. Herein, (a) denotes a cross-sectional view in a case where a liquid channel formed between the upper and lower pieces is a circumferential surface gap 14, and (b) denotes a cross-sectional view in a case where the same is minute channels 61. FIG. 103 is an exploded view of the nozzle 8 of the present invention.

As shown in FIG. 104, the upper piece 65 is provided with a plurality of concentric walls 67 at its inside, and is provided with a discharge channel 34 at its center portion. Similar to the upper piece 65, the lower piece 66 is provided with concentric walls 67 at its inside, as shown in FIG. 101, and the concentric walls 67 of both are fitted with each other while its longitudinal section has a pectinate form. At this time, a channel 68 through which contents flow is formed between the walls 67 of both. And, by such a construction, reverse flow channels for flowing in a direction opposite to the original discharging direction toward a discharge opening 12 from the container body 2 are provided, and in the present embodiment, a reverse flow is carried out two times as shown in FIG. 101, thus by providing the narrow channels in a folding manner in a narrow space of the opening portion of the container, a channel having an extremely long length can be provided. Since the longer the channel becomes the greater in-tube resistance becomes, the channel can be applied to a low-viscosity liquid, as well in theory. However, the channel between the contents inlet of the discharge nozzle of the present invention to the discharge channel 34 is not blocked by any obstacle, and is penetrated. In FIG. 103, when the lower piece 66 is fitted in the upper piece 65, the upper end thereof is hit, and 62 denotes a projection to secure a channel (space) at this part, which is also a stopper. Thereby, a space 69 for reversing the contents is formed halfway through the liquid channel 68.

This liquid channel 68 is formed with such dimensions that, at a certain pressure or less, contents (liquid) flowing therethrough block the channel by its own viscosity or surface tension and cannot flow therethrough. That is, the lower the viscosity of the contents becomes, the narrower the dimension required for the gap, while on the other hand, if the viscosity is high, a wide gap is sufficient. And, the certain pressure herein mentioned means a greatness of a force (negative pressure) which is produced, mainly after contents are pushed out by pressing the container 2, by a resilient restorative force, etc., of the container body 2 in the container body to draw back the contents into the container body.

For usage of the nozzle 8 of the present invention formed as in the above and the present container 1 provided with the same, description is given as in the following.

As shown in FIG. 104 by arrows, the contents are pushed out to the discharge opening side by an increase in the internal pressure as a result of a pressure from the outside of the container body 2 and enter a channel entrance at the lower end of the nozzle 8 of the present invention. Although the contents cannot enter the channel 68 with a weak pressing force since the entrance of the channel 68 is narrow, if a pressing force exceeding a certain pressing force is applied to the container body 2, the contents proceed into the channel 68, flow to the discharge opening 12 while reversing in the reversing space 69 to be discharged.

Then, when the pressure onto the container body 2 is stopped after a desired amount of contents has been discharged, since the container body 2 intends to restore itself by its own resilience against the atmospheric pressure which the surface of the container body 2 receives, a negative pressure is produced in the container body, and as shown in FIG. 105, a force works on the contents in the channel 68 in a direction to draw the contents into the container body. However, with this degree of negative pressure, since the contents are restricted from flowing by its own viscosity and surface tension and resistance in the channel and cannot flow against the resistance in the channel, the contents block the channel 68 and remain stagnated inside the channel 68.

For a balance of ease in discharging the contents (ease in flowing) and the function for preventing a backflow (difficulty in flowing), shown in FIG. 106, it is sufficient to appropriately adjust the dimensions of respective flow channels of the contents, namely, a gap dimension W1 of the liquid channel 68, a dimension W2 of the reversing space 69, an inside diameter W3 of the discharge channel 34, and an inside diameter W4 of the discharge opening 12.

In the present embodiment, for the channel 68, two patterns of providing the same as a circumferential surface gap channel and providing the same as minute channels can be considered. As forming methods of the channel, the methods the same as those of the aforementioned respective embodiments are applied.

### Embodiment 18

FIG. 107 through FIG. 114 show an eighteenth embodiment of an always-open-type discharge nozzle of the present invention.

FIG. 107 is a longitudinal sectional view showing the center of a main part in the vicinity of an opening portion, wherein a nozzle 8 of the present invention has been inserted inside a cylindrical portion 29 of a container 1 of the present invention shown in FIG. 26.

For the nozzle 8 of the present invention, as shown in FIG. 109, an inner 71 is fitted inside a cylindrical outer 70. The outer 70 has a shape provided with a plane portion at the upper end of a cylindrical member and having a discharge opening 12 provided in a standing condition at its center, and this is penetrated from its lower-end opening to the upper-end discharge opening 12.

The inner 71 is provided with a slit 72 in the thickness direction halfway (in FIG. 107, at two positions) in the longitudinal direction in a manner penetrating in the diametrical direction. Similar to the liquid channel 68 of the above-described Embodiment 24, this slit 72 is formed with such dimensions that, at a certain pressure or less, contents (liquid) flowing therethrough block the channel by its own viscosity or surface tension and cannot flow therethrough. In addition, a flat portion 73 is provided so as to join these slits 72. This flat portion 73 is also formed at positions connecting the slit 72 to the upper and lower end portions. FIGS. 108(a) and (b) are cross-sectional views along Y1-Y1 and Y2-Y2 of FIG. 107. In addition, FIG. 110 is a longitudinal sectional view along Y3-Y3, and FIG. 111 is a longitudinal sectional view along Y4-Y4.

As such, by providing narrow channels in a folding manner in a narrow space of an opening portion of the container by repeating a reversal a plurality of times, a channel having an extremely long length can be provided.

The nozzle 8 of the present invention constructed as such is, in the present embodiment, to be inserted inside the cylindrical portion 3 from the container body side. Then, to a screw 6 provided on the cylindrical portion 3, a cap 7 is directly attached.

For usage of the nozzle 8 of the present invention formed as in the above and the present container provided with the same, description is given as in the following.

As shown in FIG. 112 by an arrow, the contents are pushed out to the discharge opening side by an increase in the internal pressure as a result of a pressure from the outside of the container body 2, enter the flat portion 73 at the lower end of the inner 71, and enter an entrance of the first slit 72. Although the contents cannot enter the slit 72 with a weak pressing force since the entrance of the slit 72 is narrow, if a pressing force exceeding a certain pressing force is applied to the container body 2, the contents flow through the first slit 72 from right to left in the page surface as shown in FIG. 112 by an arrow, change direction at the flat portion 73, and then enter the second slit 72. And furthermore, the contents flow out the second slit 72, again change direction at the second flat portion 73, and flow to the discharge opening 12 to be discharged.

Then, when the pressure onto the container body 2 is stopped after a desired amount of contents has been discharged, owing to actions similar to those of Embodiment 1, the contents and outer air are never drawn back (never flow back) into the container body against a negative pressure working on the contents remaining in the channel as shown in FIG. 113.

For a balance of ease in discharging the contents (ease in flowing) and the function for preventing a backflow (difficulty in flowing), shown in FIG. 114, it is sufficient to appropriately adjust the dimensions of respective flow channels of the contents, namely, respective dimensions of a thickness dimension W1 of the flat portion 73, a dimension W2 of the slit 72, and an inside diameter W3 of the discharge opening 12.

### Embodiment 19

FIG. 115 through FIG. 118 show a nineteenth embodiment of an always-open-type discharge nozzle of the present invention.

FIG. 115 is a longitudinal sectional view showing the center of a main part in the vicinity of an opening portion, wherein a nozzle 8 of the present invention is inserted in an upper-end opening portion of a cylindrical portion 3 of a container 1 of the present invention and has been fixed by a nozzle cap 5.

For the nozzle 8 of the present invention, as shown in the drawings, a male screw 6 is formed on a cylindrical upper piece 65 provided with a flange 32, with which a cup-like lower piece 66 provided with, at its inside diameter, a female screw to match the same is screwed. Both are screwed together with a desirable gap at the screwed screws. And, similar to the liquid channel 68 of the above-described Embodiment 24, this gap is formed with such dimensions that, at a certain pressure or less, contents (liquid) to flow therethrough block the channel 68 by its own viscosity or surface tension and cannot flow therethrough, and a helicoidal channel 74 is formed along the screw thread. By forming the channel in a helicoidal shape as such, a channel having an extremely long length can be provided in a narrow space of an opening portion of the container. In FIG. 115, 75 denotes an opening to be a junction channel to the helicoidal channel 74 provided at the upper end of the lower piece 66.

For usage of the nozzle of the present invention formed as in the above and the present container provided with the same, description is given as in the following.

As shown in FIG. 116 by an arrow, the contents are pushed out to the discharge opening side by an increase in the internal pressure as a result of a pressure from the outside of the container body 2, flow in between the lower piece 66 and the cylindrical portion 3, and reach the opening 75 at the upper end of the lower piece 66. There, the contents enter the opening 75 and proceed into the helicoidal channel 74. Although the contents cannot enter helicoidal channel 74 with a weak pressing force since the entrance of the helicoidal channel 74 is narrow, if a pressing force exceeding a certain pressing force is applied to the container body 2, the contents flow inside the helicoidal channel toward the container body side opposite to its original discharging direction. When the contents reach a bottom portion of the lower piece 66, the contents flow between the same and the lower end of the upper piece 65 in a direction toward a center portion and flow from a discharge channel 34 to a discharge opening 12 to be discharged.

Then, when the pressure onto the container body 2 is stopped after a desired amount of contents has been discharged, owing to actions similar to those of Embodiment 1, the contents and outer air are never drawn back (never flow back) into the container body against a negative pressure working on the contents remaining in the channel as shown in FIG. 117.

For a balance of ease in discharging the contents (ease in flowing) and the function for preventing a backflow (difficulty in flowing), shown in FIG. 118, it is sufficient to appropriately adjust the dimensions of respective flow channels of the contents, namely, respective dimensions of a gap dimension W1 of the helicoidal channel 75, an inside diameter W2 of the discharge channel, and an inside diameter W3 of the discharge opening 12.

FIG. 119 and FIG. 120 show other constructional examples of this embodiment.

In FIG. 119, a top portion of a screw thread of one screw (in the drawing, the female screw of the lower piece 66) is deleted, and a helicoidal channel 75 is formed between the screw thread and a groove portion of another screw (in the drawing, the male screw 6 of the upper piece 65). In FIG. 120, a screw thread is formed at only one screw, and the whole of a groove portion of the screw is provided as a channel by insertion while keeping the other straight. In such a case as in the above where the screw thread is utilized, the screw shape is not limited.

### Embodiment 20

FIG. 121 through FIG. 127 show a twelfth embodiment of an always-open-type discharge nozzle of the present invention.

FIG. 121 is a longitudinal sectional view showing the center of a main part in the vicinity of an opening portion, wherein a nozzle 8 of the present invention has been inserted in an upper-end opening portion of a cylindrical portion 3 of a container 1 of the present invention and has been fixed by a nozzle cap 29.

For the nozzle 8 of the present invention shown in FIG. 122, as shown in FIG. 123 and FIG. 124, a spiral protruded thread 75 is formed on a cylindrical upper piece 65 provided with a flange 32, with which a lower piece 66 provided with a spiral protruded thread 76 with an identical shape matching the same with a desirable gap is fitted one onto the other. FIG. 123 is a cross-sectional view along Z-Z of FIG. 122. And, similar to the liquid channel 68 of the above-described Embodiment 24, this gap is formed with such dimensions that, at a certain pressure or less, contents (liquid) to flow therethrough block the channel by its own viscosity or surface tension and cannot flow therethrough, and a spiral channel 77 is formed along the protruded thread 76. By forming the channel in a spiral shape as such, a channel having an extremely long length can be provided in a narrow and thin space of an opening portion of the container. In FIG. 122, 78 denotes an inflow opening into the channel 77. Here, for the channel 77, as shown in FIG. 125, the protruded thread 76 may be formed on only one piece. In the drawing, this is formed on only the lower piece 66.

For usage of the nozzle of the present invention formed as in the above and the present container provided with the same, description is given as in the following.

As shown in FIG. 126 by an arrow, the contents are pushed out to the discharge opening side by an increase in the internal pressure as a result of a pressure from the outside of the container body 2 and proceed into the spiral channel 77 from the inflow opening 78 provided on the outer circumference of the lower piece 66. Although the contents cannot enter spiral channel 77 with a weak pressing force since the entrance of the spiral channel 77 is narrow, if a pressing force exceeding a certain pressing force is applied to the container body 2, the contents flow inside the spiral channel 77 toward the center. When the contents reach the center of the lower piece 66, the contents flow into a discharge channel 34 and flow to a discharge opening 12 to be discharged.

Then, when the pressure onto the container body 2 is stopped after a desired amount of contents has been discharged, owing to actions similar to those of Embodiment 1, the contents and outer air are never drawn back (never flow back) into the container body against a negative pressure working on the contents remaining in the channel.

For a balance of ease in discharging the contents (ease in flowing) and the function for preventing a backflow (difficulty in flowing), shown in FIG. 127, it is sufficient to appropriately adjust the dimensions of respective flow channels of the contents, namely, respective dimensions of gap dimensions W1 and W2 of the spiral channel 77, and an inside diameter of a discharge opening 6.

### Embodiment 21

FIG. 128 and FIG. 129 are perspective views of a nozzle 8 showing a twenty-first embodiment of an always-open-type discharge nozzle of the present invention. For the nozzle 8 formed in an almost cylindrical form as a whole, channels which are not penetrated through the upper and lower end faces, respectively, are provided in the longitudinal direction, and the lower-end side is provided as an entrance channel 79, and the upper-end side is provided as a discharge channel 34. On the outer circumference, partition walls 81 in which slits 80 are provided at appropriate positions and which are parallel to both end surfaces are provided in proximity with a desirable gap in the longitudinal direction.

And, similar to the liquid channel 68 of the above-described Embodiment 24, these gaps are formed with such dimensions that, at a certain pressure or less, contents (liquid) to flow therethrough block the channel by its own viscosity or surface tension and cannot flow therethrough, and a maze-like channel 82 connecting the gaps between the respective partition walls and slits 80 is formed. In FIG. 129, 83 denotes a junction channel between the entrance channel 79 and discharge channel 34 at the upper and lower ends of the maze-like channel 82. By forming the channel in a maze-like shape as such, a channel having an extremely long length is provided in a narrow space of an opening portion of the container.

For usage of the nozzle 8 of the present invention formed as in the above and the present container provided with the same, description is given as in the following.

As shown in FIG. 129 by an arrow, the contents are pushed out to the discharge opening side by an increase in the internal pressure as a result of a pressure from the outside of the container body 2 and proceed into the entrance passage 79. The contents pass from the entrance channel 79 through the junction channel 83 and flow out into the maze-like channel 82. Although the contents cannot enter maze-like channel 82 with a weak pressing force since the maze-like channel 82 is narrow, if a pressing force exceeding a certain pressing force is applied to the container body 2, the contents flow inside the maze-like channel 82 toward upper end. When the contents reach the upper end of the maze-like channel 82, the contents flow into the discharge channel 34 through the junction channel 83 and flow to a discharge opening 12 to be discharged.

Then, when the pressure onto the container body 2 is stopped after a desired amount of contents has been discharged, owing to actions similar to those of Embodiment 1, the contents and outer air are never drawn back (never flow back) into the container body against a negative pressure working on the contents remaining in the channel.

FIG. 130 through FIG. 132 show other constructional examples of this maze-shaped channel.

In FIG. 130, innumerous protrusions 84 are provided in place of the above-described partition walls 81. The contents utilize the gaps formed by these protrusions 84 as a maze-shaped liquid channel 82.

In FIG. 131, grooves in the circumferential direction are provided on the outer circumference of the nozzle 8 to form a maze-shaped liquid channel 82, through which the contents which have flowed out from an entrance channel 79 through a junction channel 83 flow zigzag upward.

In FIG. 132, a maze-shaped liquid channel 82 for flowing zigzag up and down and in the circumferential direction is formed. In FIG. 131 and FIG. 132, although the liquid channel 82 has been widely drawn, as a matter of course, similar to the liquid channel 68 of the above-described Embodiment 24, the gaps to form the channel are formed with such dimensions that, at a certain pressure or less, contents (liquid) flowing therethrough block the channel 68 by its own viscosity or surface tension and cannot flow therethrough.

### Embodiment 22

FIG. 133 and FIG. 134 show a twenty-second embodiment of a discharge nozzle of the present invention.

FIG. 133 is a longitudinal sectional view showing the center of a main part in the vicinity of an opening portion of a container 1 of the present invention.

In the present embodiment, in addition to the constructions of the above-described Embodiments 1 through 21, a flat plate-like backflow prevention valve 85 (hereinafter, a check valve) is further provided on an opening portion of the upper end of a nozzle 8 of the present invention so as to block this opening portion and is fixed by a nozzle cap 3. In this flat plate-like check valve 85, at least one slit is provided. And, FIG. 134 are plan views showing constructions of slits provided in the check valve 85. The check valve 85 is an elastic body such as rubber formed in a plate-like form, in which, as shown in (a) through (e), at least one slit 86 is formed. It is desirable that this slit 86 is structured so as to be closed in a normal condition, to be opened only by an increase in pressure inside the container body, and to be never opened in reverse.

For usage of the nozzle 6 of the present invention formed as in the above and the present container 1 provided with the same, description is given as in the following.

As shown in FIG. 135 by an arrow, the contents are pushed out to the discharge opening side by an increase in the internal pressure as a result of a pressure from the outside of the container body 2 and enter a minute channel entrance (opening) 13 at the lower end of the nozzle 8 of the present invention. Although the contents cannot enter a first channel 14A with a weak pressing force since the entrance is narrow, if a pressing force exceeding a certain pressing force is applied to the container body 2, the contents proceed into the first channel 14A and flow to a landing space 15. And, the contents reverse in this space 15 and proceed into a second channel 14B. The contents which have flowed out of the second channel 14B again reverse toward a discharge opening 12 and push and expand the check valve 85 to be discharged from the discharge opening 12.

Then, when the pressure onto the container body 2 is stopped after a desired amount of contents has been discharged, the container body 2 intends to restore itself by its own resilience against the atmospheric pressure which the surface of the container body 2 receives, a negative pressure is produced in the container body, and as shown in FIG. 136, a force works on the contents in the discharge channel in a direction to draw the contents into the container body. However, with this degree of negative pressure, the contents remain stagnated inside the channel since the contents are restricted from flowing by its own viscosity and surface tension and resistance in the channel and not only can the contents not flow against the resistance in the channel but also the check valve 85 works to block the nozzle discharge opening 12. Accordingly, the contents are never drawn back (never flow back) into the container body.

Accordingly, when discharging the contents again, the contents are immediately discharged from the discharge opening 12 by pressing the container body 2 at a force required for the contents being discharged against the resistance in the channel.

Despite that the nozzle 8 of the present invention disclosed in the previous embodiments is constructed basically without using any movable components, malfunction or a decline in performance never occurs and the function is permanently maintained. However, as for the actions of the present embodiment, a stronger backflow preventing structure can be provided by providing the same with the check valve 85.

### Embodiment 23

FIG. 137 and FIG. 138 are longitudinal sectional view showing the main part of a twenty-third embodiment of the present invention.

In the present embodiment, a flap-like movable valve is employed as a check valve. In this case, if the viscosity of contents is high, since, as shown by an arrow in FIG. 138, there is a possibility that a valve body 85 becomes immovable after a discharge and fails to block a discharge opening 12 of a nozzle 8, this valve can be employed for a liquid having a low viscosity. In addition, this valve body 85 can be constructed so as to be closed at all times by a spring or the like.

### Embodiment 24

FIG. 139 and FIG. 140 are longitudinal sectional view showing the main part of a twenty-fourth embodiment of the present invention.

In the present embodiment, a ball-like movable valve is employed as a check valve. In this case as well, if the viscosity of contents is high, since, as shown by an arrow in FIG. 140, there is a possibility that a valve body 85 becomes immovable after a discharge and fails to block a discharge opening 12 of a nozzle 8, this valve can be employed for a liquid having a low viscosity. In addition, this valve body 85 can be constructed so as to be closed at all times by a spring or the like. In addition, the valve body 85 is not limited to a spherical body. In FIG. 139, 87 denotes a stopper of the valve body 85. Without this stopper 87, the valve body rises with the contents and blocks the discharge opening 12.

### INDUSTRIAL APPLICABILITY

According to an always-open-type discharge nozzle with a function for preventing a backflow of contents and a liquid container provided with the same of the present invention constructed as in the above, the following excellent effects which could not have been achieved by prior arts can be provided.

That is, in a flexible liquid container, such as a tube, being deformed by external pressure to discharge contents, when the pressure onto the container body is stopped after a desired amount of contents has been discharged, the container body essentially intends to restore itself by its own resilience, so that a negative pressure is produced in the container body, and a force works on the contents in the gap channels and discharge channel in a direction to draw the contents into the container body. However, with this degree of negative pressure, the contents are restricted from flowing by its own viscosity and surface tension and resistance in the channel and cannot flow against the resistance in the channel. So the contents block the gaps and remain stagnated inside the channel, and are never drawn back (never flow back) into the container body.

Accordingly, when discharging the contents again, the contents are immediately discharged from the discharge opening by pressing the container body at a force required for the contents being discharged against the resistance in the channel. Because of the absence of such a process as in the conventional container to first discharge air drawn in the container body and then push out the contents, a container whose response to an external pressure is excellent can be provided.

Furthermore, since no air is drawn into the container body, this is preferable for contents which have an aversion toward oxidation.

In addition, at the front end of the discharge opening, contact between the contents and air can be reduced to none as much as possible by preventing the contents existing at the forefront from making contact with air by providing, inside the cap, a packing coming into contact with the front end of this discharge opening when the cap is closed.

Moreover, as for these actions, malfunction never occurs and the function is permanently maintained since the nozzle of the present invention has been constructed without using any movable components.

Conventionally, for stopping a flow of a liquid flowing in a channel, a movable valve has been used in common sense terms. However, such actions can be realized by the nozzle with a function for preventing a backflow of contents of the present invention despite not being provided with such a movable valve as in the prior art and being an always-open-type, which is a considerable breakthrough.

For the contents, since excellent actions are indicated not only for a high-viscosity liquid but also for a low-viscosity liquid such as water, it becomes possible to use a tube container for a low-viscosity liquid, which has priorly been considered to be difficult.

Furthermore, by adding a check valve to such a construction, a secure backflow preventing effect more excellent in performance can be obtained.

### BRIEF DESCRIPTION OF DRAWINGS

FIG. 1 shows an overall perspective view showing a first embodiment of the present invention.

FIG. 2 is a longitudinal sectional view showing the main part.

FIG. 3 is a sectional view along A-A.

FIG. 4 is an exploded view of a nozzle.

FIG. 5 is a sectional view along B-B.

FIG. 6 is an exploded view of a nozzle.

FIG. 7 is a sectional view along C-C.

FIG. 8 is an exploded view of a nozzle.

FIG. 9 is a sectional view along D-D.

FIG. 10 is a conceptual view showing a flow at the time of discharge of contents.

FIGS. 11(a) and (b) are cross-sectional views showing the main part of other constructional examples of gaps.

FIG. 12 is a conceptual view showing a negative pressure working on contents.

FIG. 13 is a conceptual view showing dimensions of the respective portions.

FIG. 14 an exploded view of a nozzle showing a second embodiment of the present invention.

FIG. 15 is a longitudinal sectional view showing the main part.

FIG. 16 is a sectional view along E-E.

FIG. 17 is a conceptual view showing a flow at the time of discharge of contents.

FIG. 18 is a longitudinal sectional view showing the main part of another constructional example.

FIG. 19 is a conceptual view showing a negative pressure working on contents.

FIG. 20 is a longitudinal sectional view showing the main part of a third embodiment of the present invention.

FIG. 21 is an exploded view of a nozzle.

FIG. 22 is a sectional view along F-F.

FIG. 23 is a conceptual view showing a flow at the time of discharge of contents.

FIG. 24 is a conceptual view showing a negative pressure working on contents.

FIG. 25 is a conceptual view showing dimensions of the respective portions.

FIG. 26 is an overall perspective view showing a fourth embodiment of the present invention.

FIG. 27 is a longitudinal sectional view showing the main part.

FIG. 28 is an exploded view of a nozzle.

FIG. 29 is a sectional view along G-G.

FIG. 30 is a sectional view along H-H.

FIG. 31 is a conceptual view showing a flow at the time of discharge of contents.

FIG. 32 is a conceptual view showing a negative pressure working on contents.

FIG. 33 is a conceptual view showing dimensions of the respective portions.

FIG. 34 is a longitudinal sectional view showing the main part of another constructional example.

FIG. 35 is a longitudinal sectional view showing the main part of another constructional example.

FIG. 36 is a longitudinal sectional view showing the main part of a fifth embodiment of the present invention.

FIG. 37 is a perspective view of a nozzle.

FIG. 38 is an exploded view of a nozzle.

FIG. 39 is a sectional view along J-J.

FIG. 40 is a conceptual view showing a flow at the time of discharge of contents.

FIG. 41 is a conceptual view showing a negative pressure working on contents.

FIG. 42 is a conceptual view showing dimensions of the respective portions.

FIG. 43 is a longitudinal sectional view showing the main part of another constructional example.

FIG. 44 is a longitudinal sectional view showing the main part of another constructional example.

FIG. 45 is a longitudinal sectional view showing the main part of a sixth embodiment of the present invention.

FIG. 46 is an exploded view of a nozzle.

FIG. 47 is a sectional view along K-K.

FIG. 48 is a sectional view along L-L.

FIG. 49 is a conceptual view showing a flow at the time of discharge of contents.

FIG. 50 is a conceptual view showing a negative pressure working on contents.

FIG. 51 is a conceptual view showing dimensions of the respective portions.

FIG. 52 is a longitudinal sectional view showing the main part of a seventh embodiment of the present invention.

FIG. 53 is an exploded view of a nozzle.

FIG. 54 is a sectional view along M-M.

FIG. 55 is a sectional view along N-N.

FIG. 56 is a conceptual view showing a flow at the time of discharge of contents.

FIG. 57 is a conceptual view showing a negative pressure working on contents.

FIG. 58 is a conceptual view showing dimensions of the respective portions.

FIG. 59 is a longitudinal sectional view showing the main part of another constructional example.

FIG. 60 is a longitudinal sectional view showing the main part of another constructional example.

FIG. 61 is a longitudinal sectional view showing the main part of an eighth embodiment of the present invention.

FIG. 62 is an exploded view of a nozzle.

FIG. 63 is a sectional view along P-P.

FIG. 64 is a plan view of a gap piece.

FIG. 65 is a bottom view of the same.

FIG. 66 is a sectional view along R-R.

FIG. 67 is a conceptual view showing a flow at the time of discharge of contents.

FIG. 68 is a conceptual view showing a flow at the time of discharge of contents.

FIG. 69 is a conceptual view showing a negative pressure working on contents.

FIG. 70 is a conceptual view showing dimensions of the respective portions.

FIG. 71 is a longitudinal sectional view showing the main part of a ninth embodiment of the present invention.

FIG. 72 is an exploded view of a nozzle.

FIG. 73 is a sectional view along S-S.

FIG. 74 is a sectional view along T-T.

FIG. 75 is a conceptual view showing a flow at the time of discharge of contents.

FIG. 76 is a conceptual view showing a negative pressure working on contents.

FIG. 77 is a conceptual view showing dimensions of the respective portions.

FIG. 78 is a sectional view along A-A of FIG. 2 showing a tenth embodiment of the present invention.

FIG. 79 is an exploded view of a nozzle.

FIG. 80 is an exploded view of a nozzle according to another construction of minute channels.

FIG. 81 is a sectional view of the same along A-A of FIG. 2.

FIG. 82 is an exploded view of a nozzle according to another construction of minute channels.

FIG. 83 is a sectional view of the same along A-A of FIG. 2.

FIG. 84 is an exploded view of a nozzle according to another construction of minute channels.

FIG. 85 is a sectional view of the same along A-A of FIG. 2.

FIG. 86 are cross-sectional views showing the main part of a construction of minute channels.

FIG. 87 are cross-sectional views showing the main part of a construction of minute channels.

FIG. 88 is a cross-sectional view along E-E of FIG. 15 showing an eleventh embodiment of the present invention.

FIG. 89 is an exploded view of a nozzle showing a twelfth embodiment of the present invention.

FIG. 90 is a cross-sectional view along F-F of FIG. 20.

FIG. 91 is an exploded view of a nozzle showing a thirteenth embodiment of the present invention.

FIG. 92 is a cross-sectional view along H-H of FIG. 24.

FIG. 93 is an exploded view of a nozzle showing a fourteenth embodiment of the present invention.

FIG. 94 is a cross-sectional view along J-J of FIG. 37.

FIG. 95 is an exploded view of a nozzle showing a fifteenth embodiment of the present invention.

FIG. 96 is across-sectional view along K-K of FIG. 42.

FIG. 97 is a cross-sectional view along L-L of FIG. 42.

FIG. 98 is an exploded view of a nozzle showing a sixteenth embodiment of the present invention.

FIG. 99 is a cross-sectional view along M-M of FIG. 52.

FIG. 100 is a cross-sectional view along N-N of FIG. 52.

FIG. 101 is a longitudinal sectional view showing the main part in the vicinity of an opening portion of a container showing a seventeenth embodiment of the present invention.

FIG. 102 are cross-sectional views along X-X of FIG. 2. (a) is a cross-sectional view where the fluid channel is a circumferential gap, and (b) is across-sectional view where the fluid channel is minute channels 60.

FIG. 103 is an exploded view of a nozzle.

FIG. 104 is a conceptual view showing a flow at the time of discharge of contents.

FIG. 105 is a conceptual view showing a negative pressure working on contents.

FIG. 106 is a conceptual view showing dimensions of the respective portions.

FIG. 107 is a longitudinal sectional view showing the main part in the vicinity of an opening portion of a container showing an eighteenth embodiment of the present invention.

FIGS. 108(a) and (b) are cross-sectional views along Y1-Y1 and Y2-Y2 of FIG. 107, respectively.

FIG. 109 is an exploded view of a nozzle.

FIG. 110 is a longitudinal sectional view along Y3-Y3.

FIG. 111 is a longitudinal sectional view along Y4-Y4.

FIG. 112 is a conceptual view showing a flow at the time of discharge of contents.

FIG. 113 is a conceptual view showing a negative pressure working on contents.

FIG. 114 is a conceptual view showing dimensions of the respective portions.

FIG. 115 is a longitudinal sectional view showing the main part in the vicinity of an opening portion of a container showing a nineteenth embodiment of the present invention.

FIG. 116 is a conceptual view showing a flow at the time of discharge of contents.

FIG. 117 is a conceptual view showing a negative pressure working on contents.

FIG. 118 is a conceptual view showing dimensions of the respective portions.

FIG. 119 is a longitudinal sectional view showing the main part of another constructional example.

FIG. 120 is a longitudinal sectional view showing the main part of another constructional example.

FIG. 121 is a longitudinal sectional view showing the main part of a twentieth embodiment of the present invention.

FIG. 122 is a perspective view of a nozzle of the present invention.

FIG. 123 is a sectional view along Z-Z.

FIG. 124 is an exploded view of a nozzle.

FIG. 125 is an exploded view of a nozzle according to another construction.

FIG. 126 is a conceptual view showing a flow at the time of discharge of contents.

FIG. 127 is a conceptual view showing dimensions of the respective portions.

FIG. 128 is a perspective view showing a twenty-first embodiment of the present invention.

FIG. 129 is a front view showing the main part of the same.

FIG. 130 is a perspective view showing another constructional example.

FIG. 131 is a perspective view showing another constructional example.

FIG. 132 is a perspective view showing another constructional example.

FIG. 133 is a longitudinal sectional view showing the main part of a twenty-second embodiment of the present invention.

FIG. 134 are plan views showing examples of slits.

FIG. 135 is a conceptual view showing a flow at the time of discharge of contents.

FIG. 136 is a conceptual view showing a negative pressure working inside a liquid channel.

FIG. 137 is a longitudinal sectional view showing the main part of a twenty-third embodiment of the present invention.

FIG. 138 is a conceptual view showing a flow at the time of discharge of contents.

FIG. 139 is a longitudinal sectional view showing the main part of a twenty-fourth embodiment of the present invention.

FIG. 140 is a conceptual view showing a flow at the time of discharge of contents.

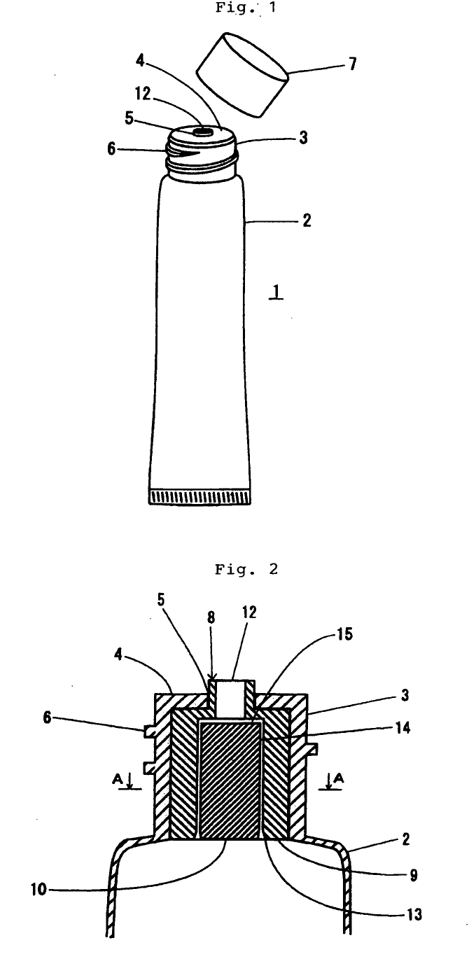

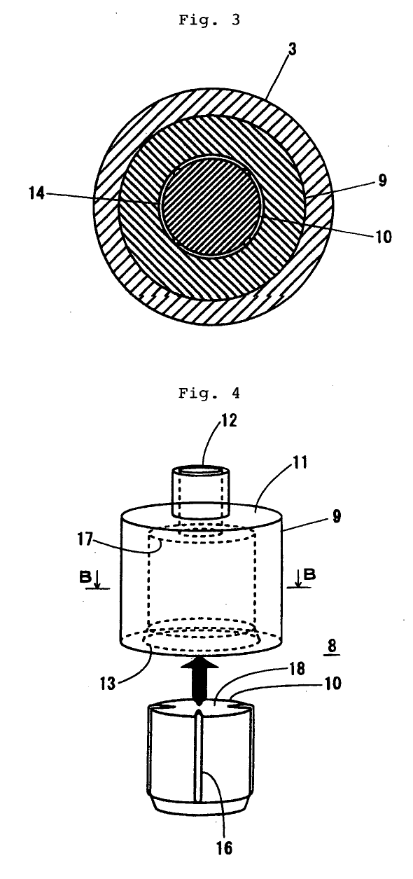

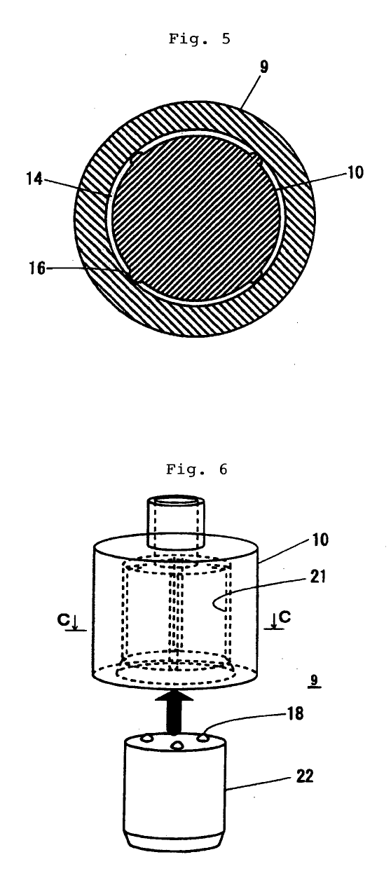

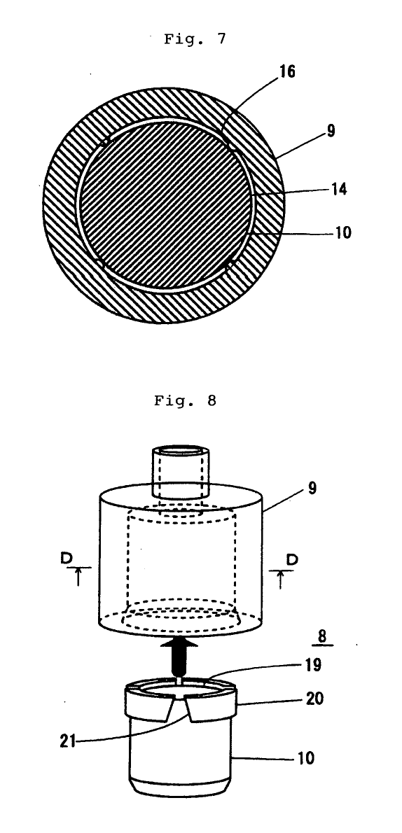

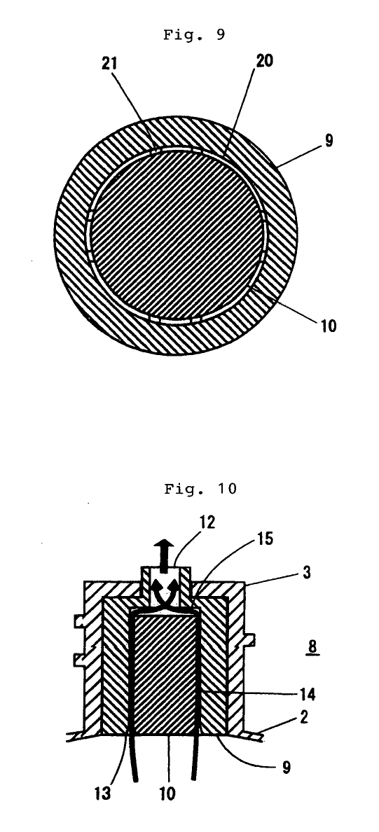

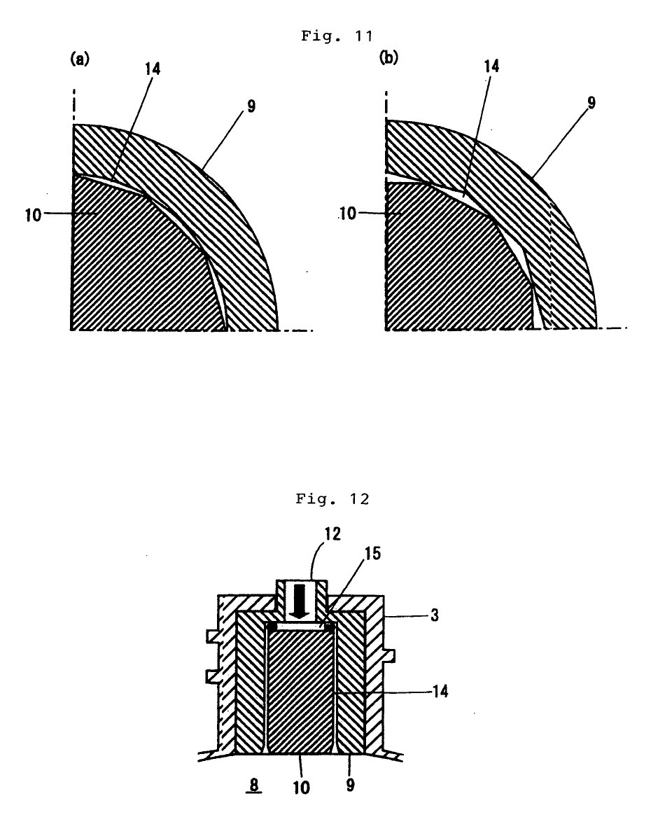

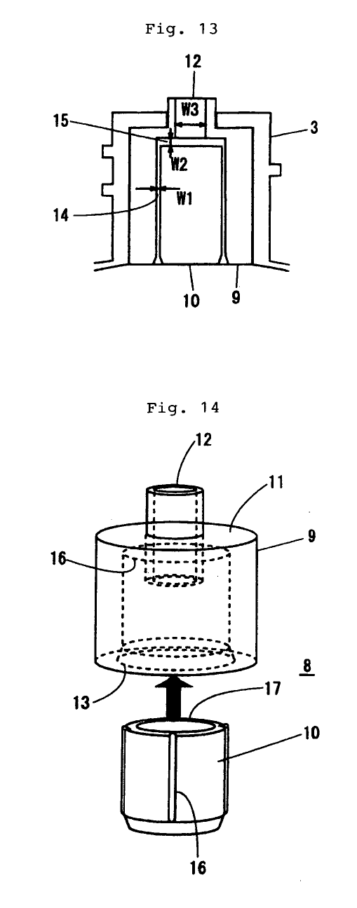

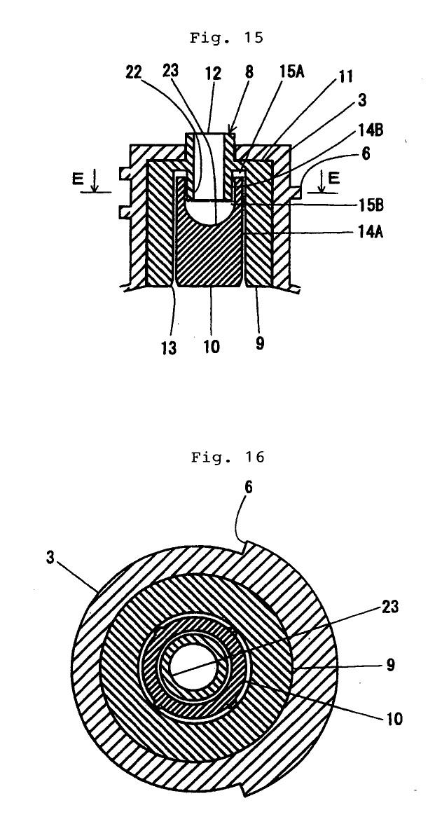

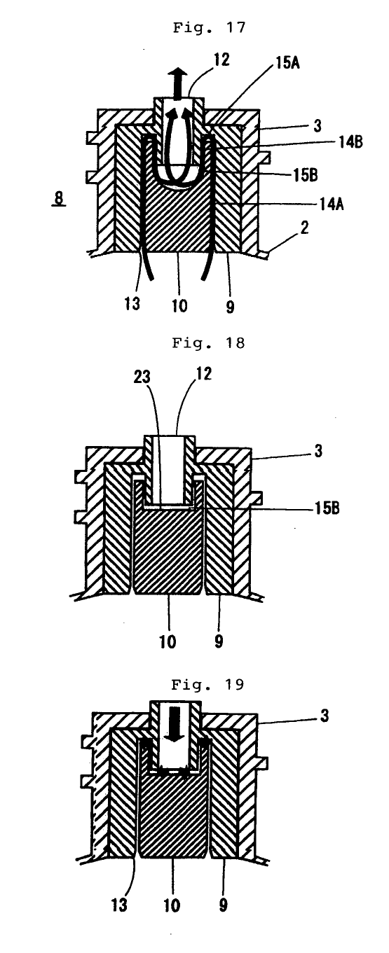

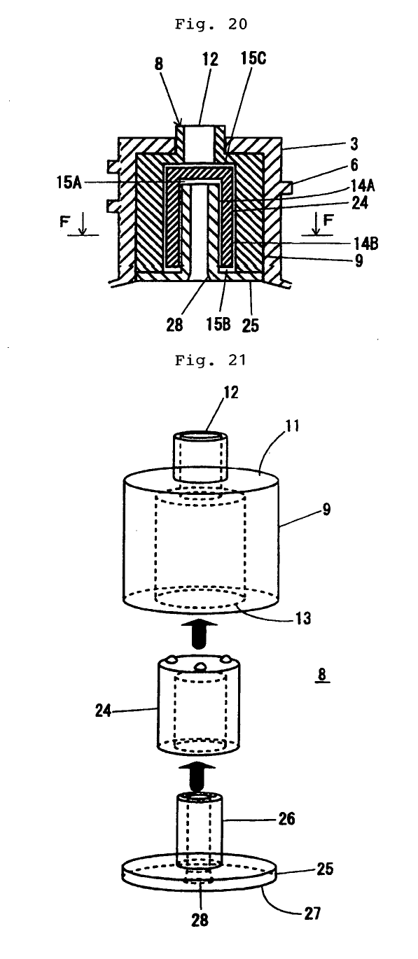

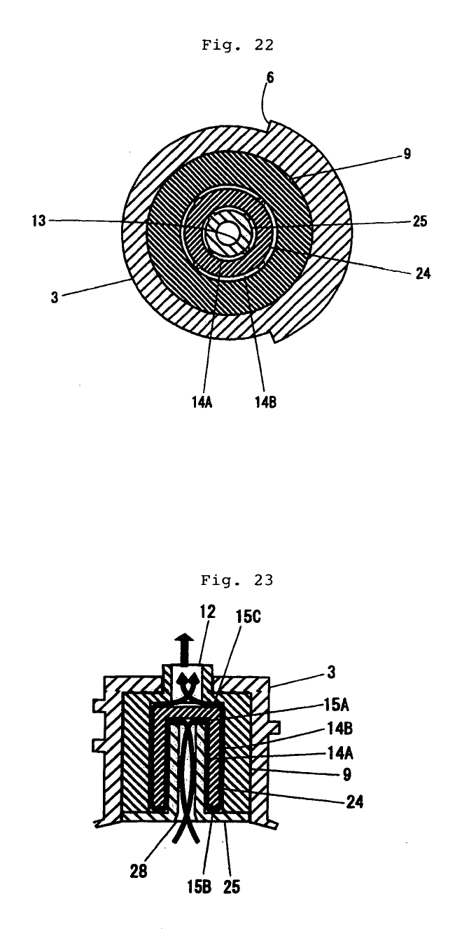

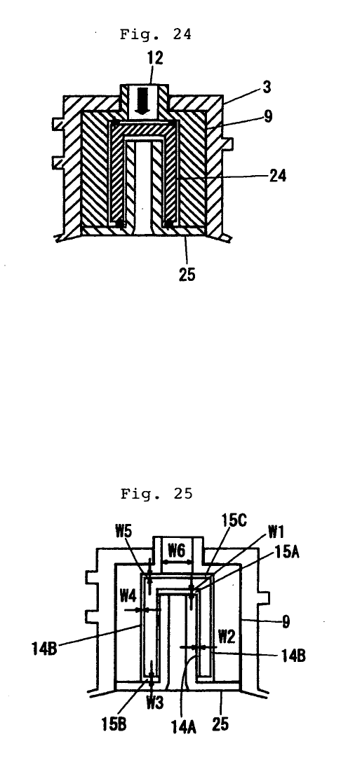

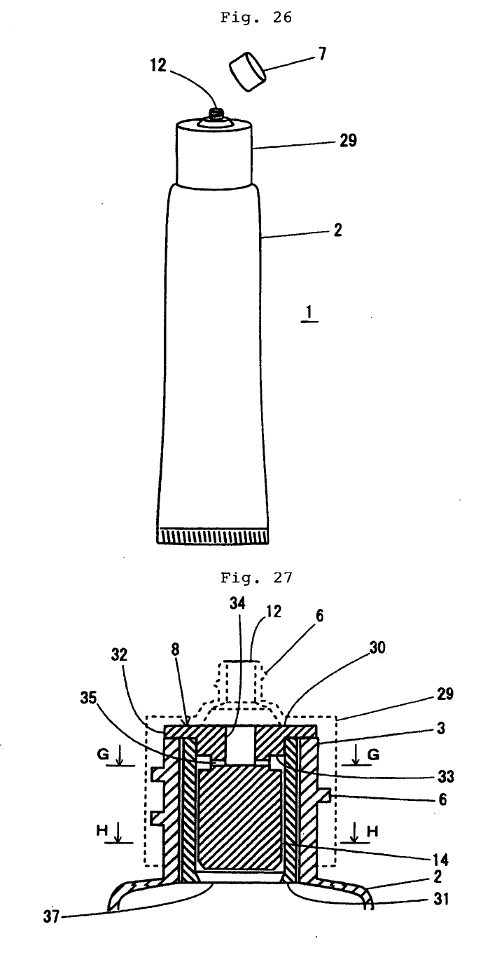

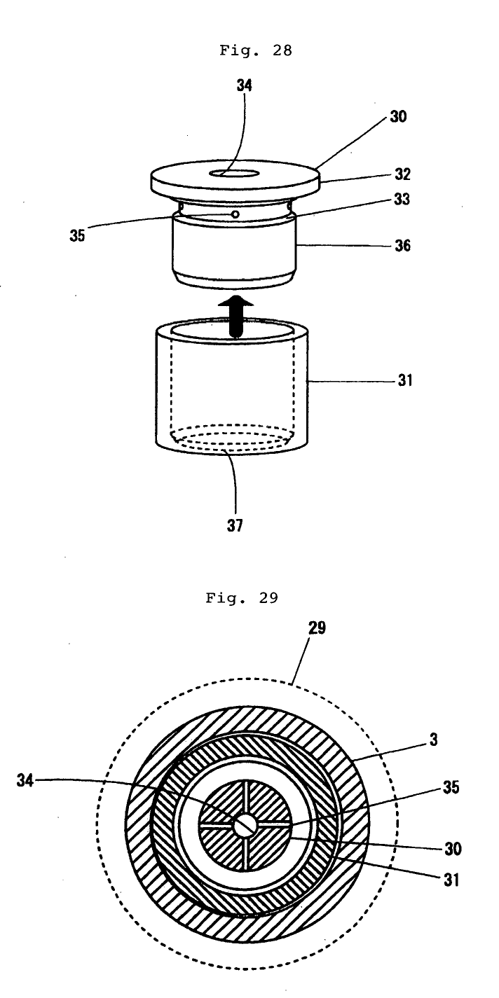

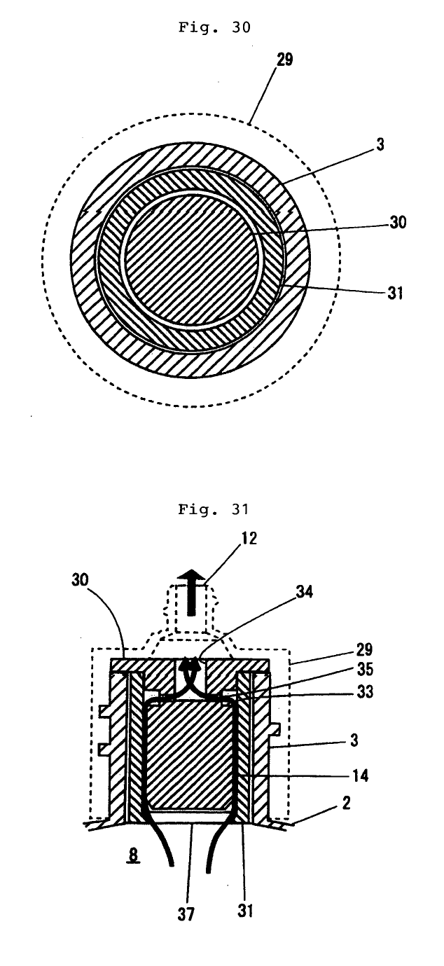

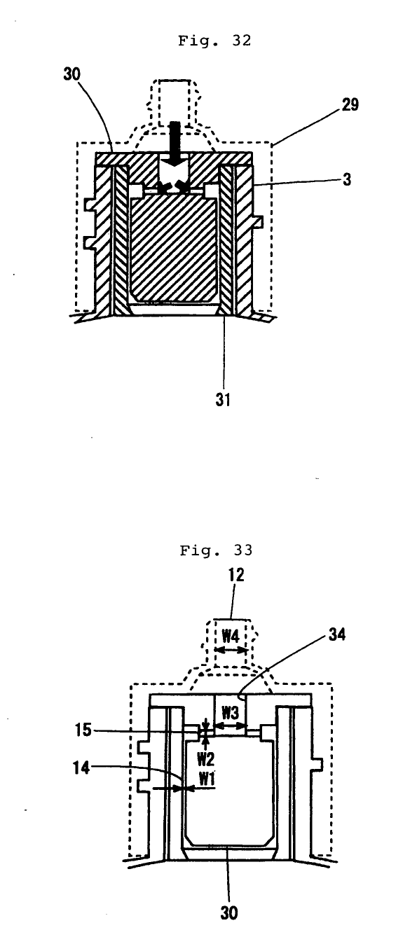

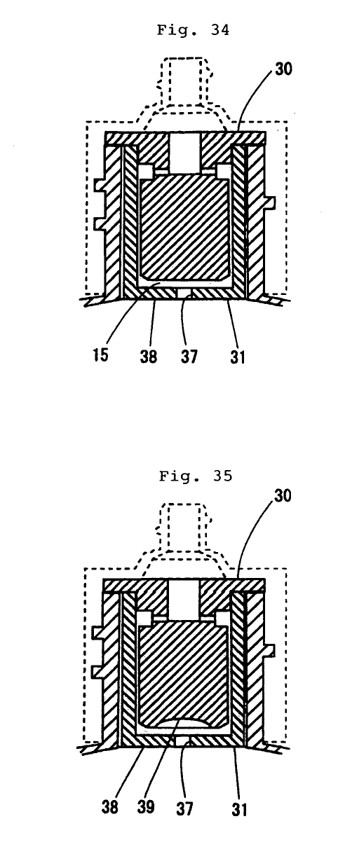

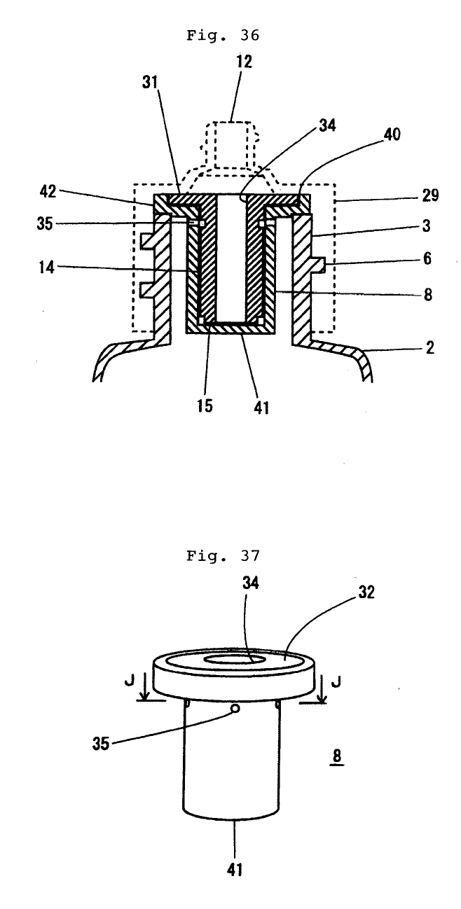

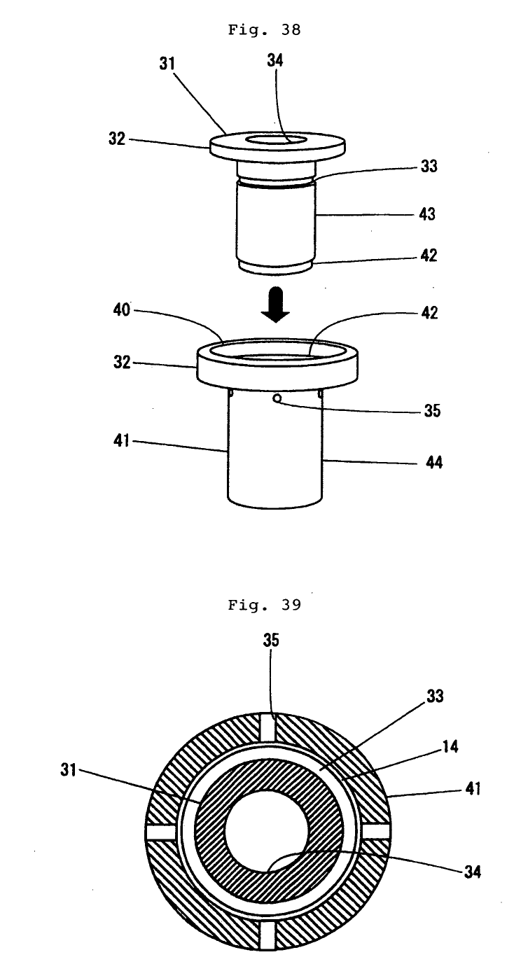

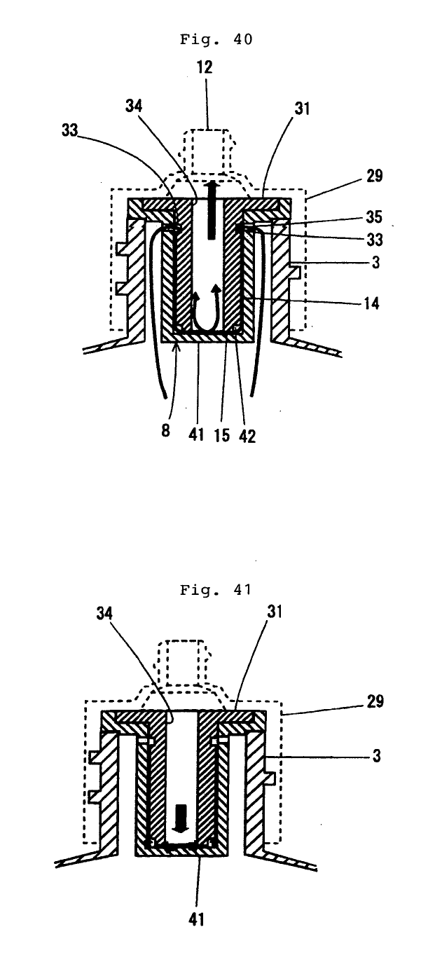

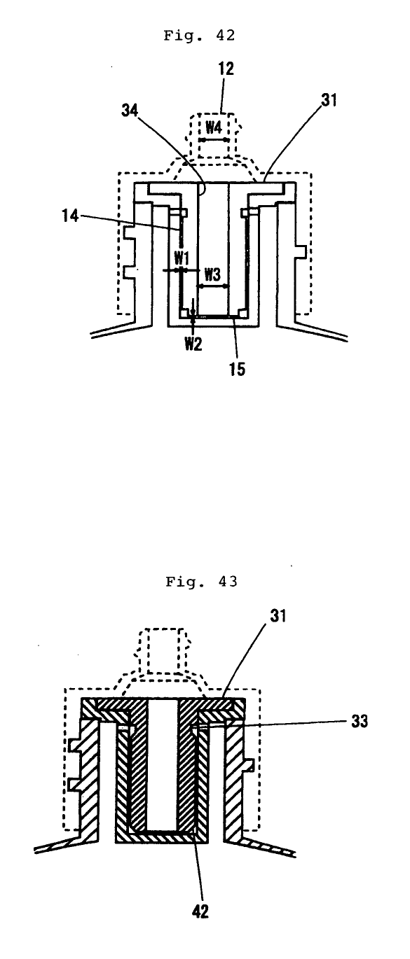

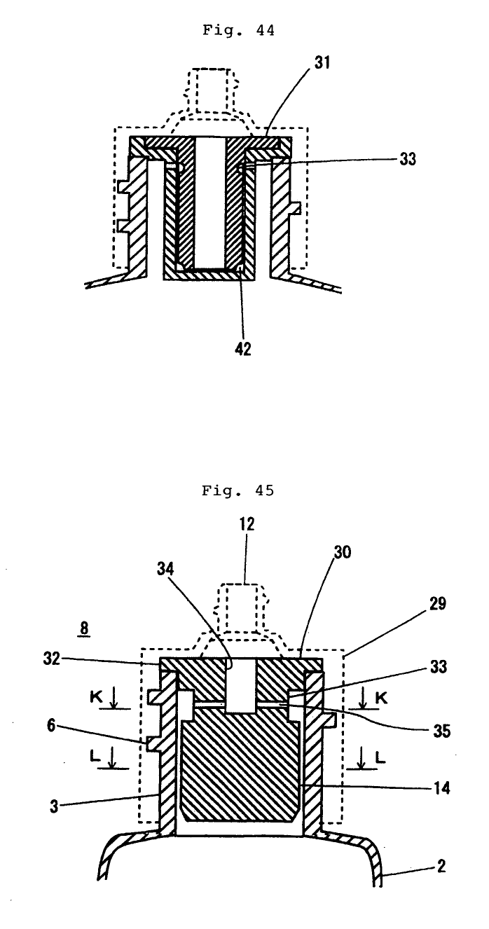

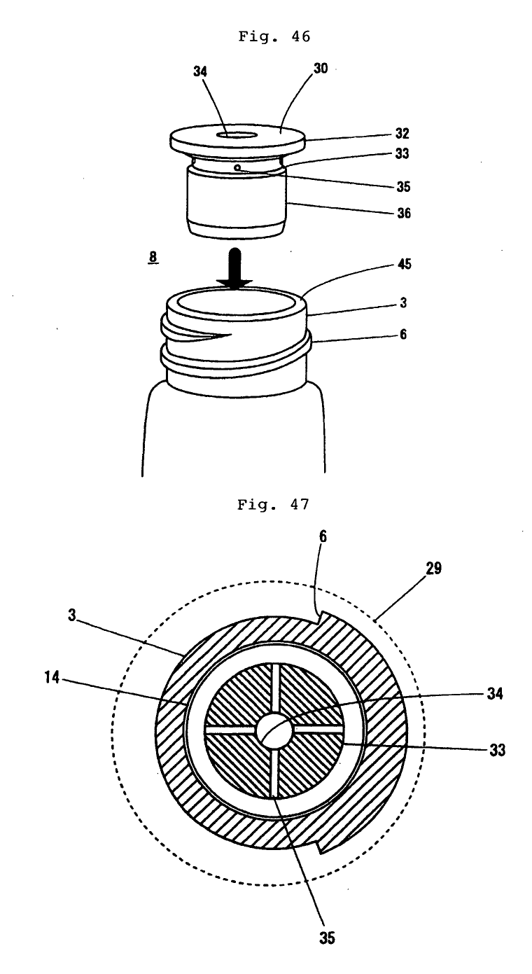

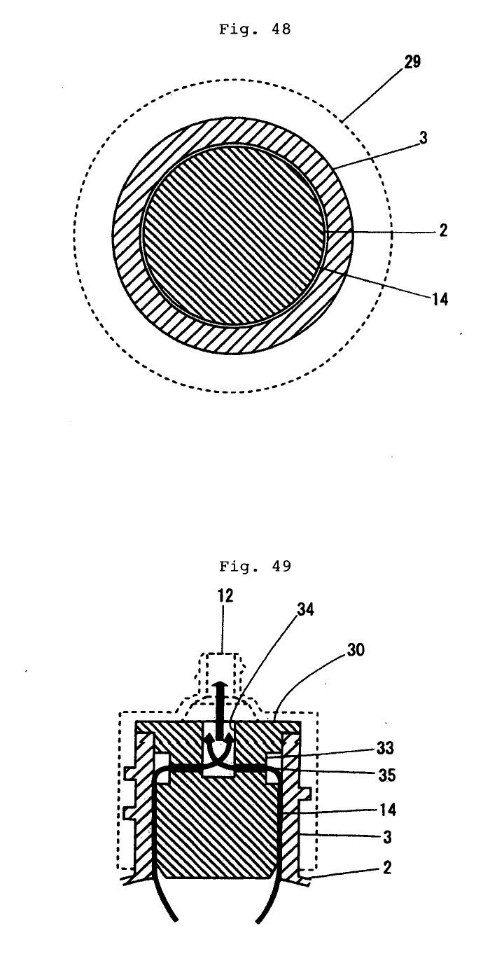

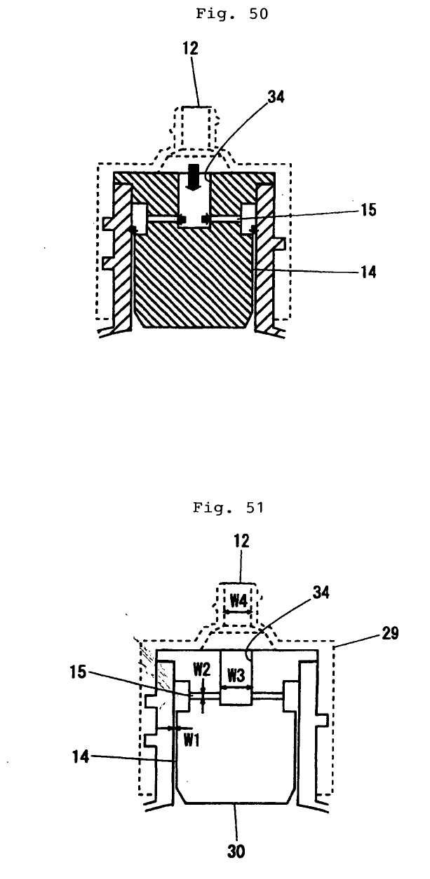

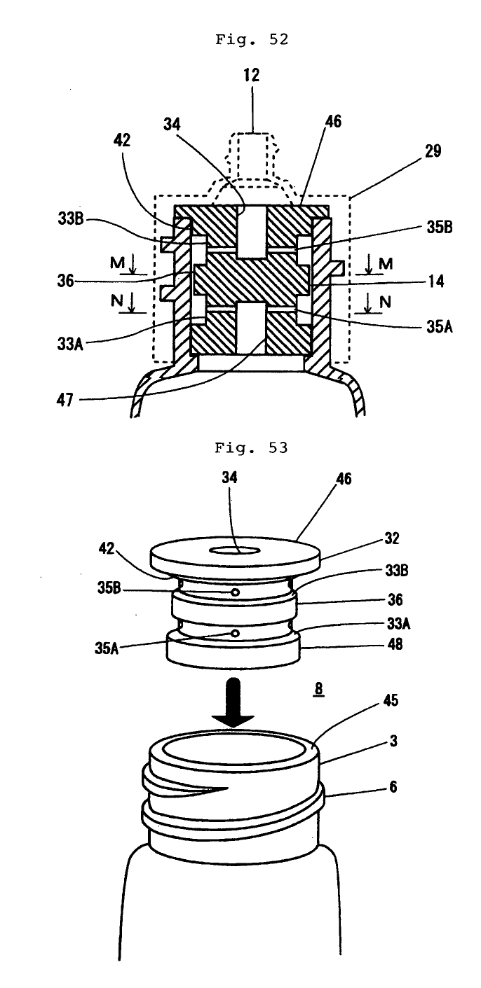

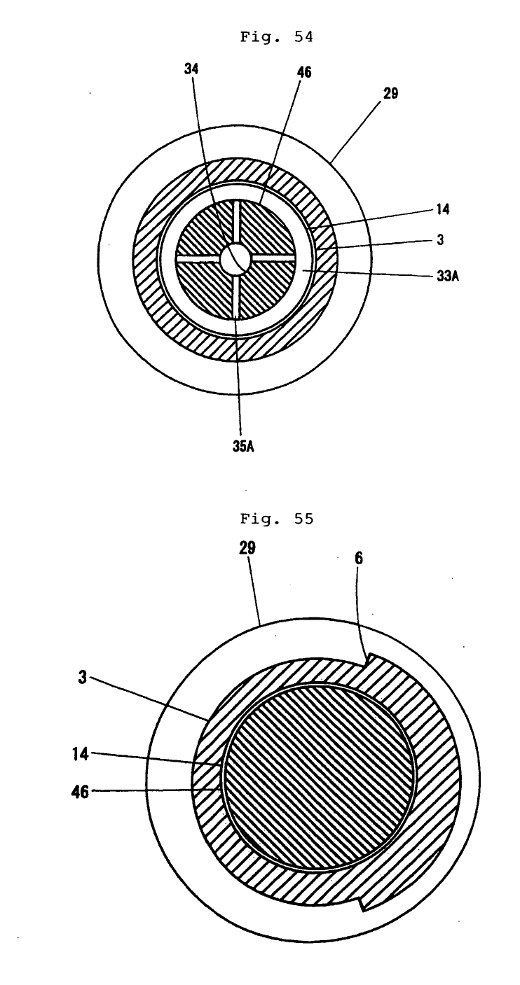

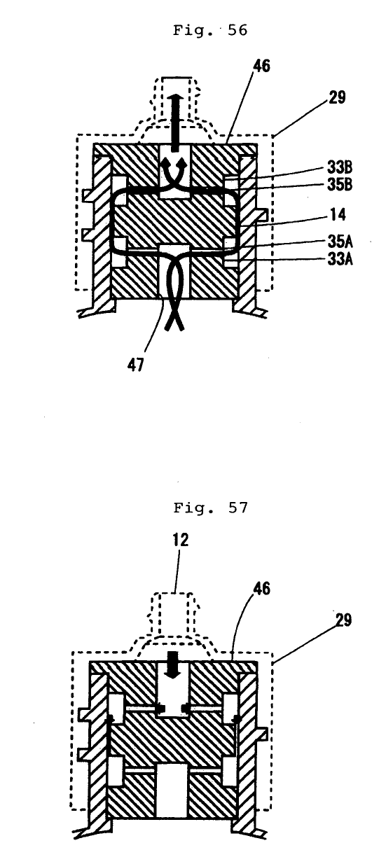

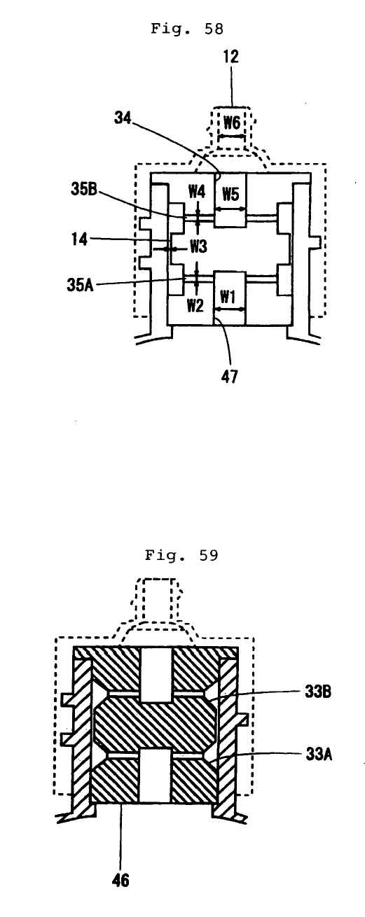

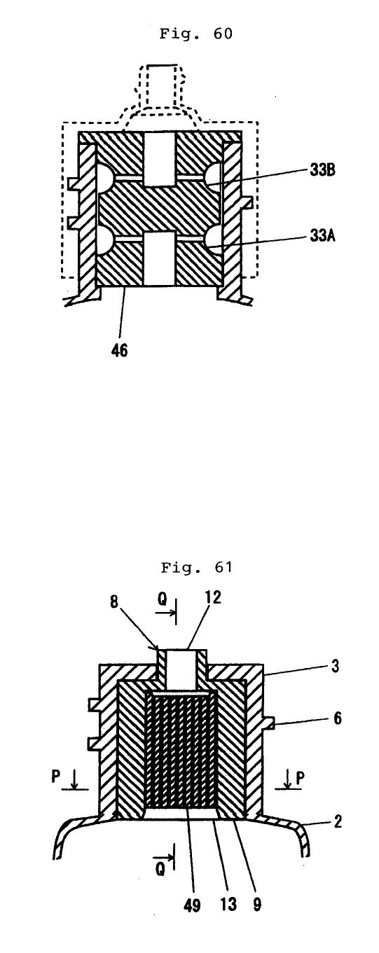

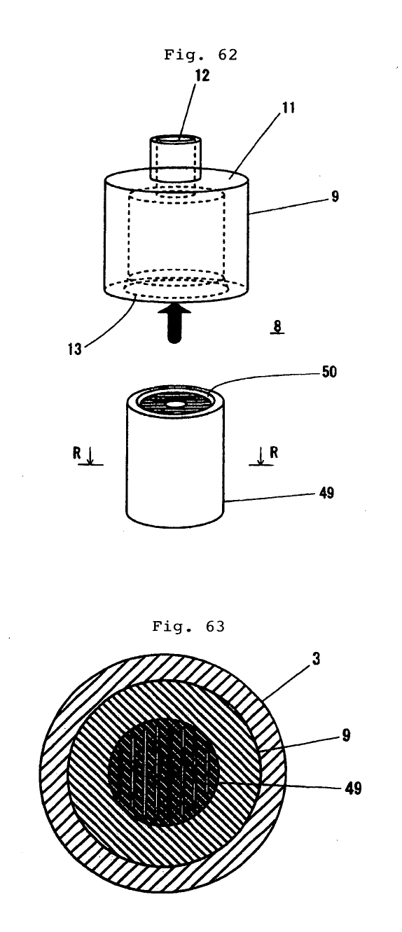

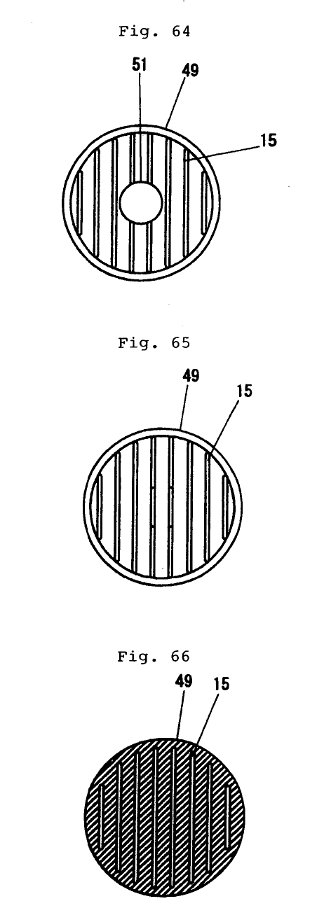

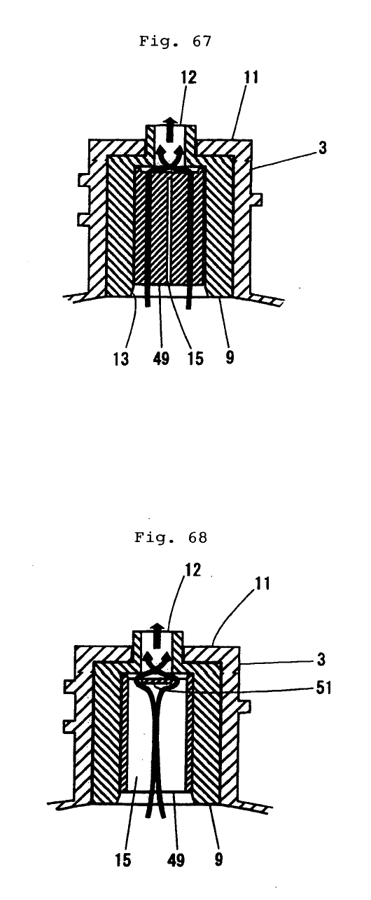

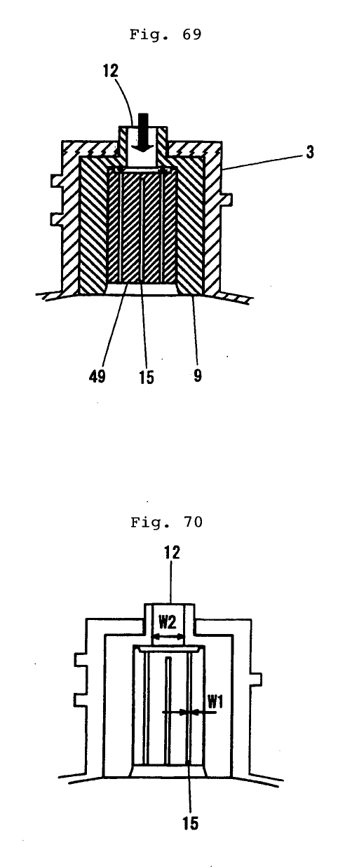

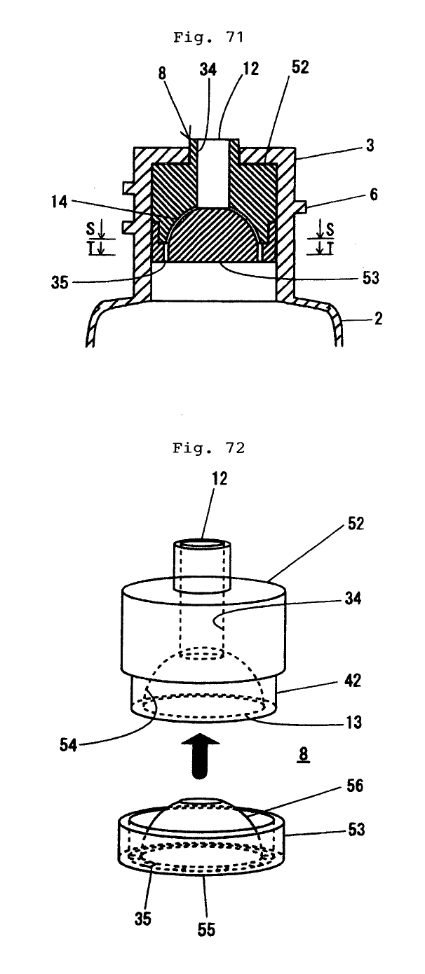

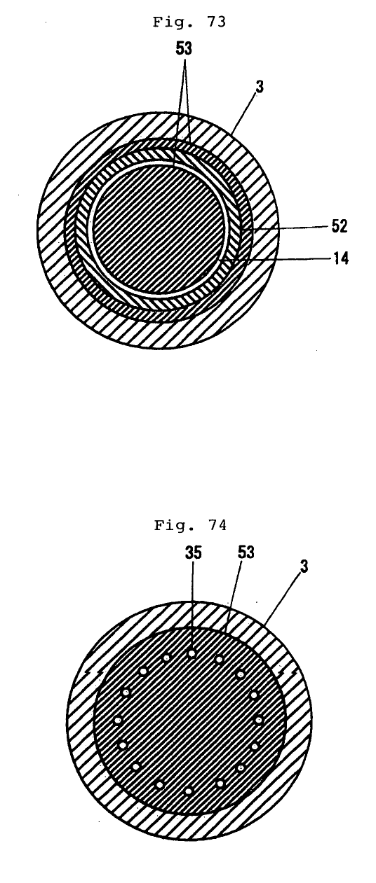

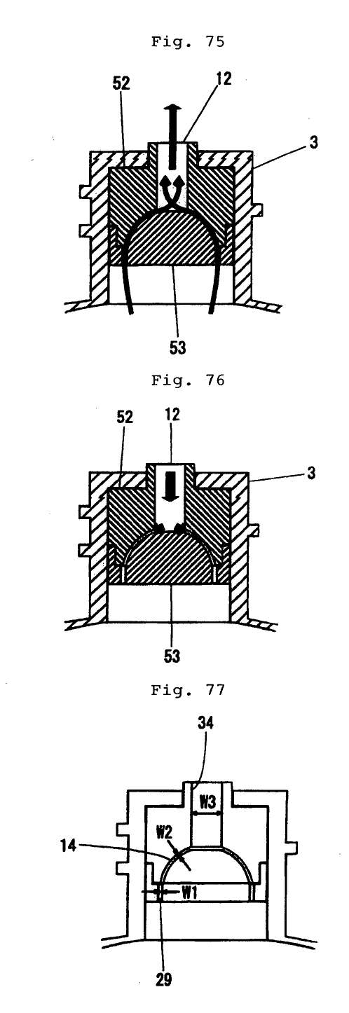

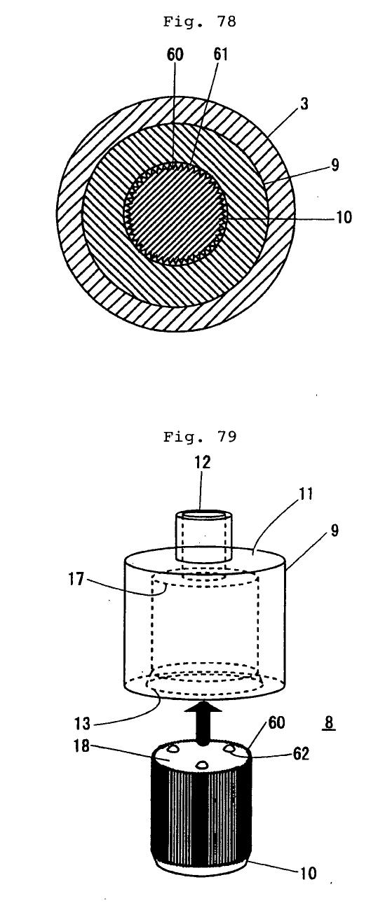

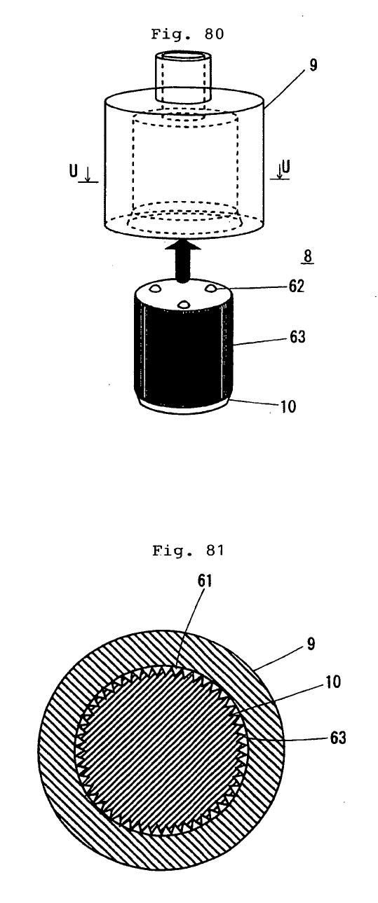

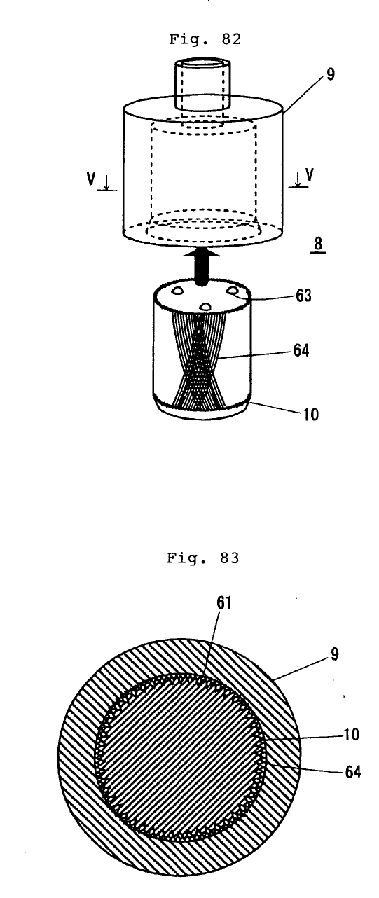

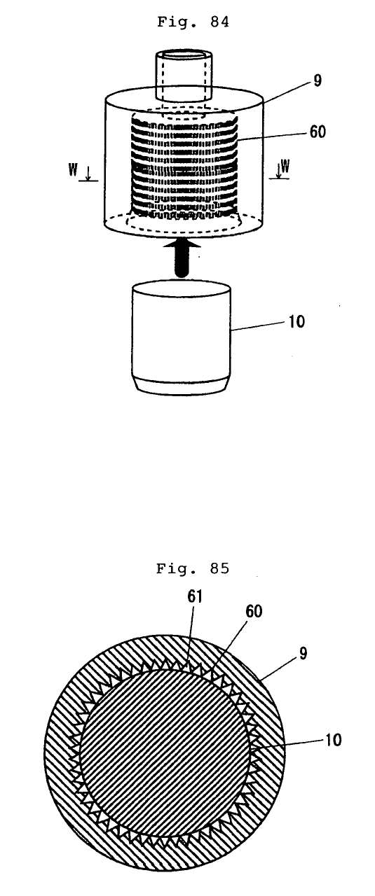

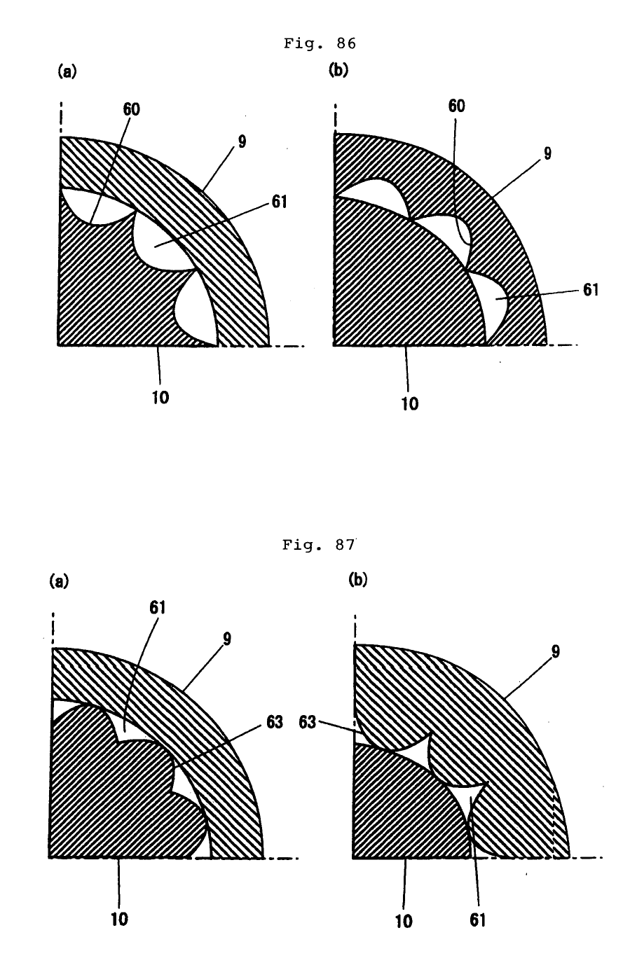

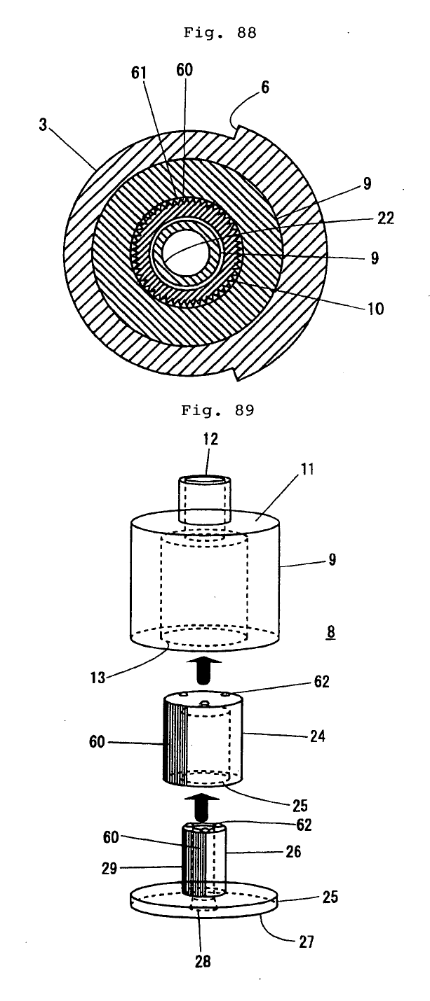

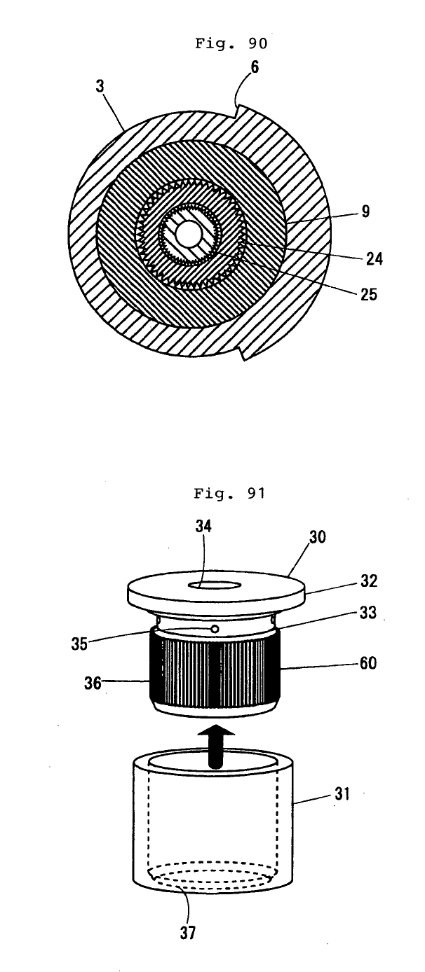

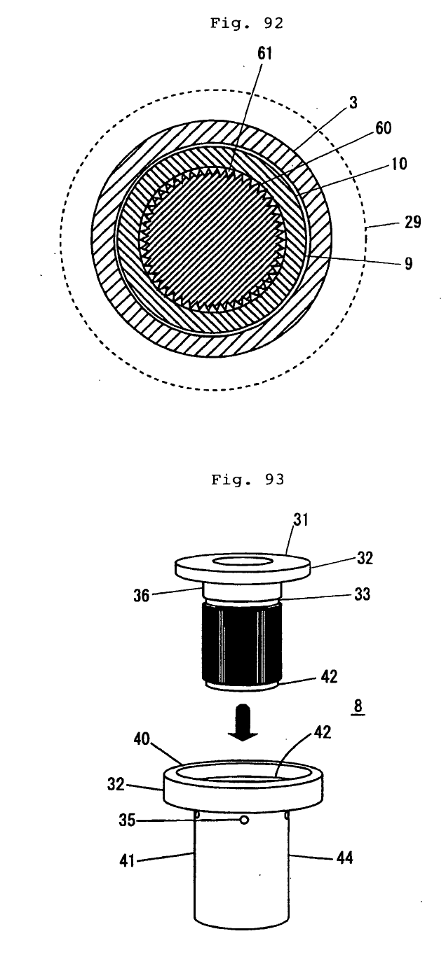

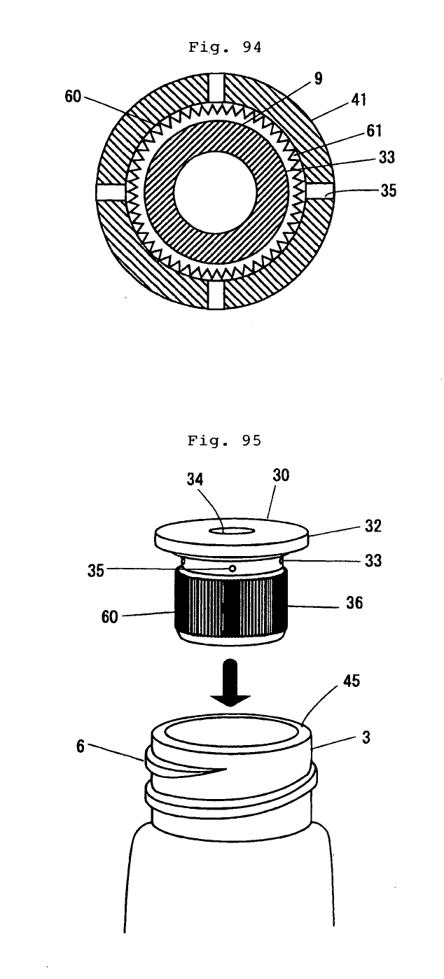

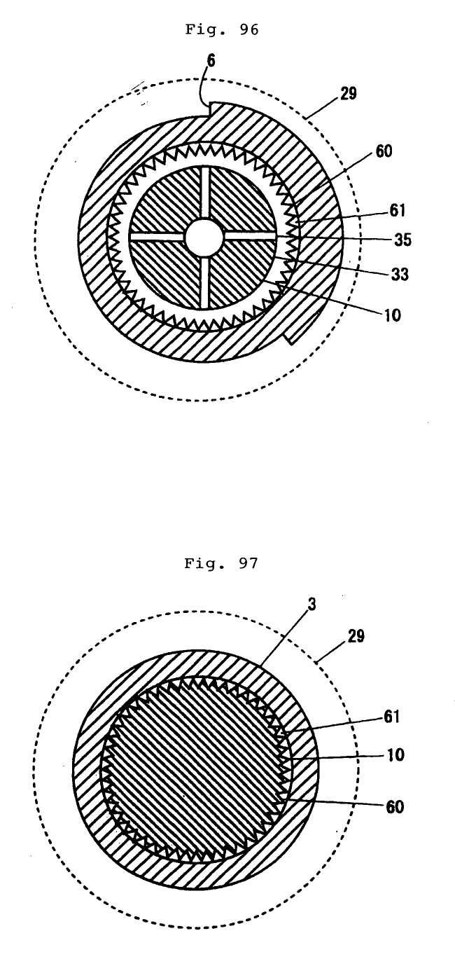

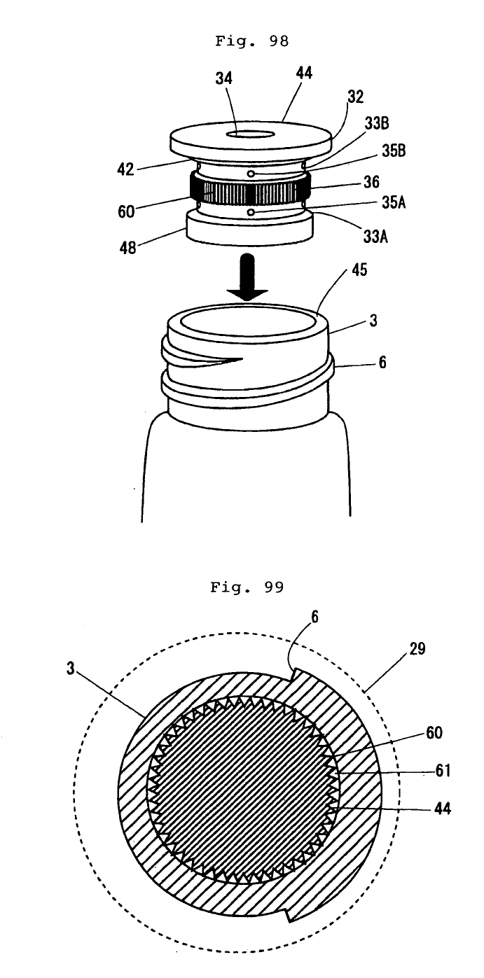

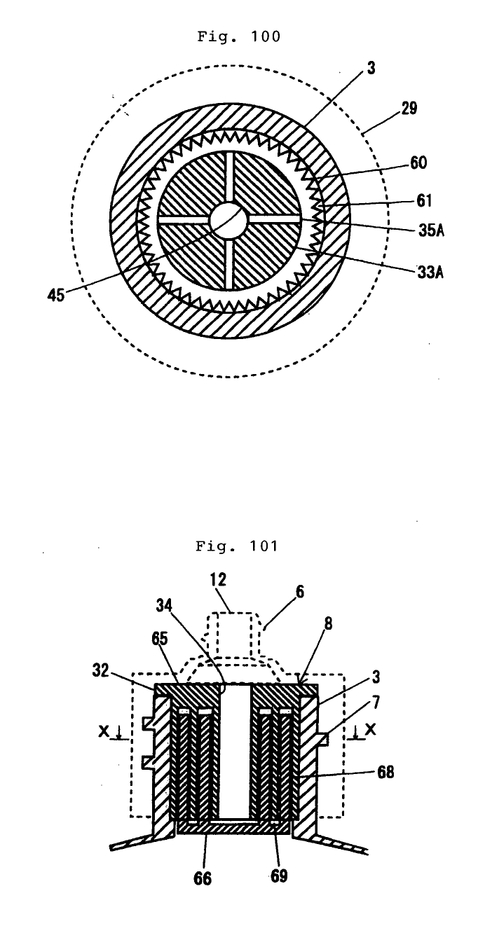

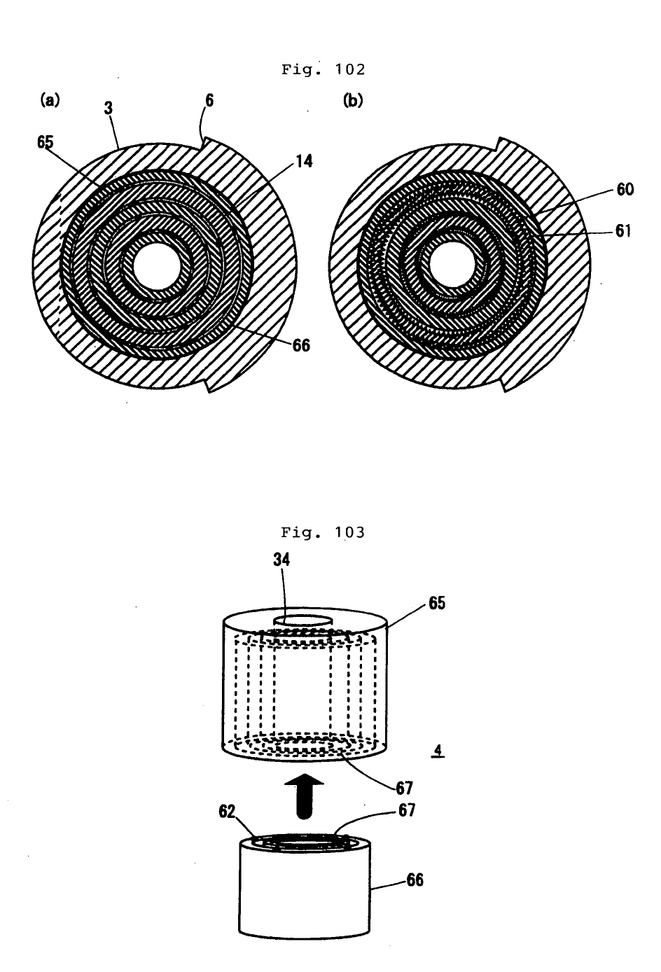

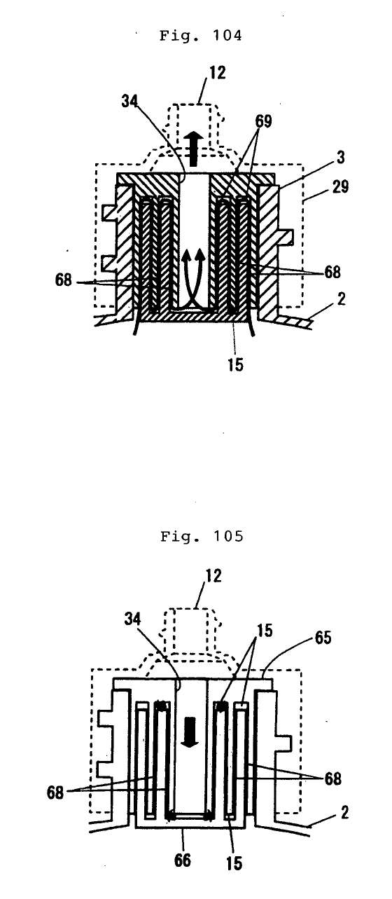

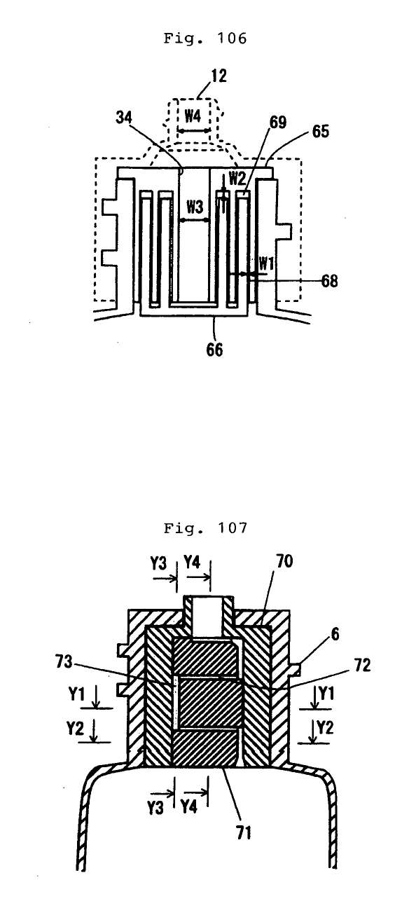

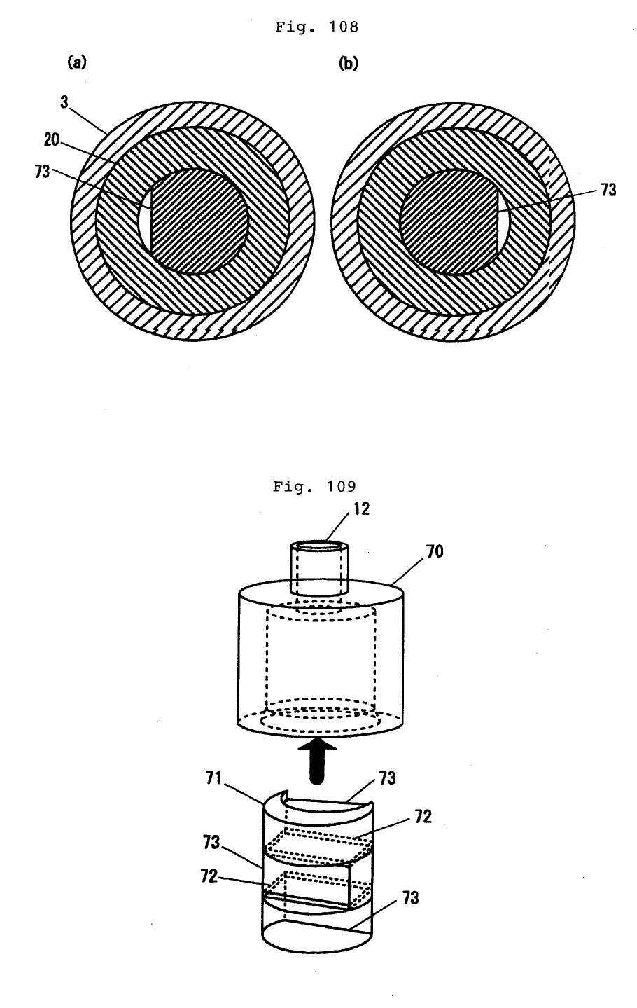

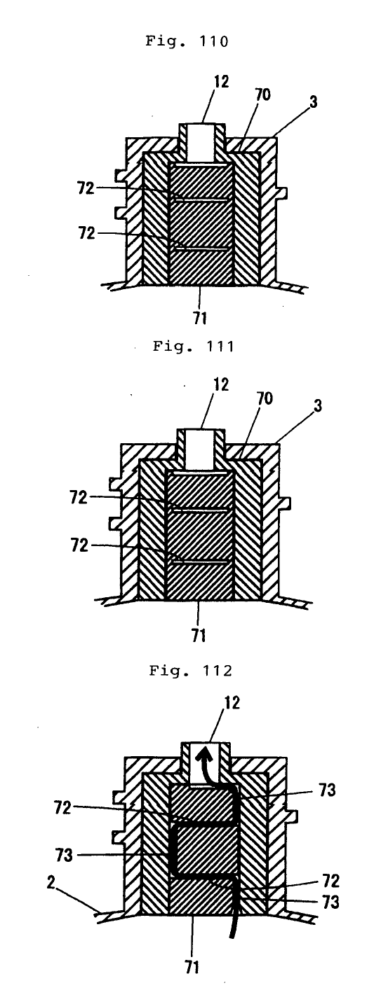

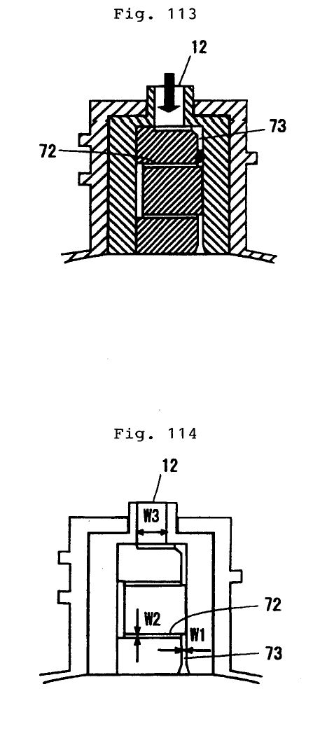

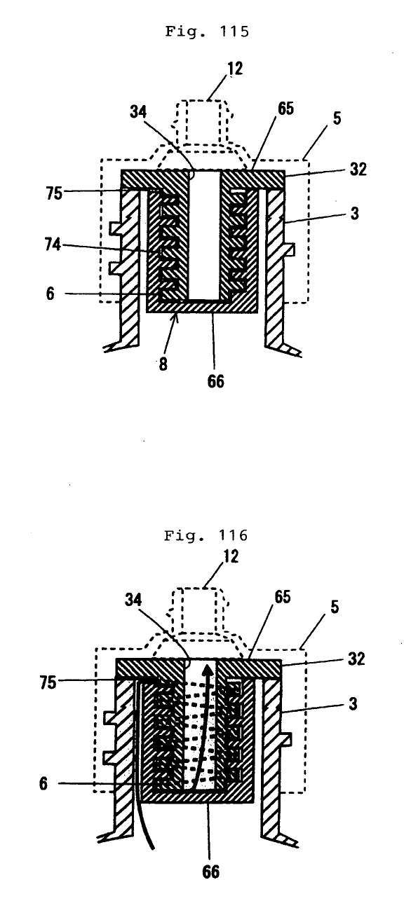

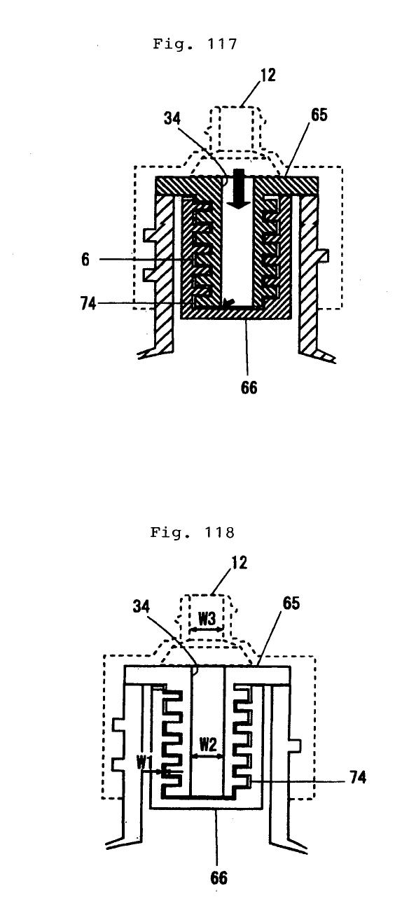

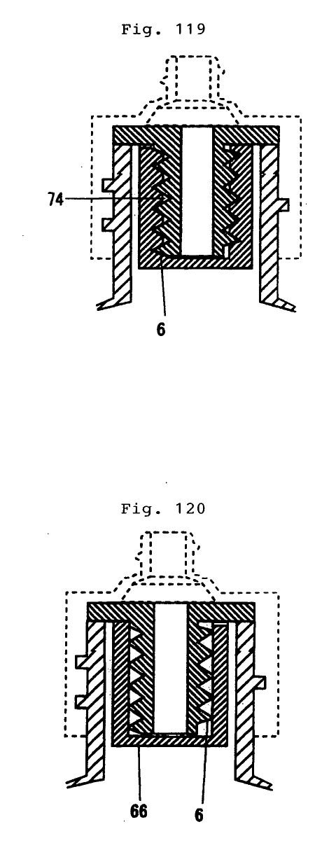

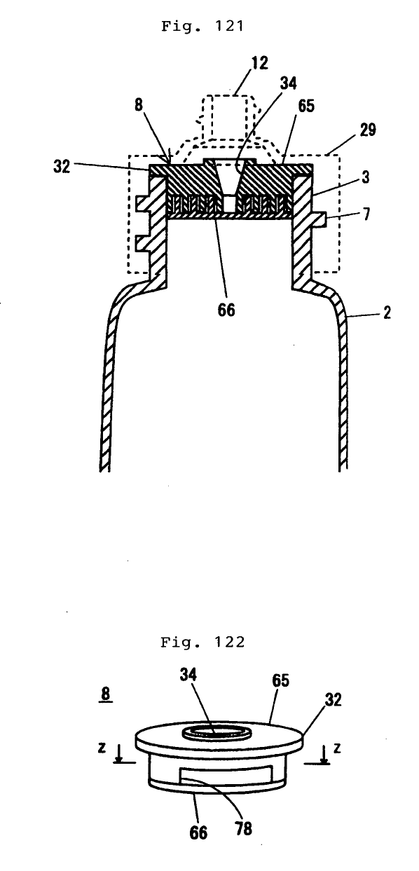

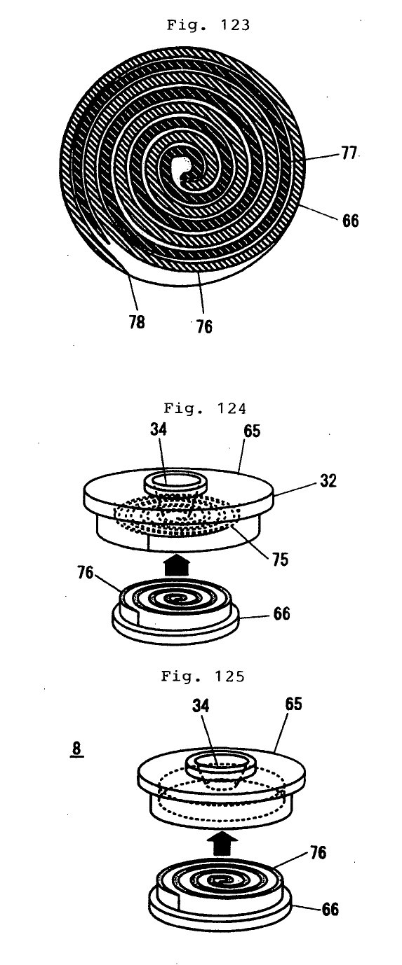

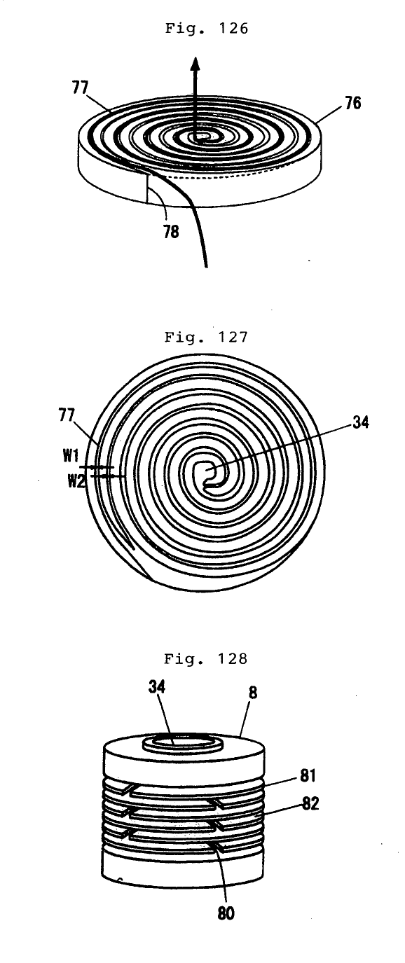

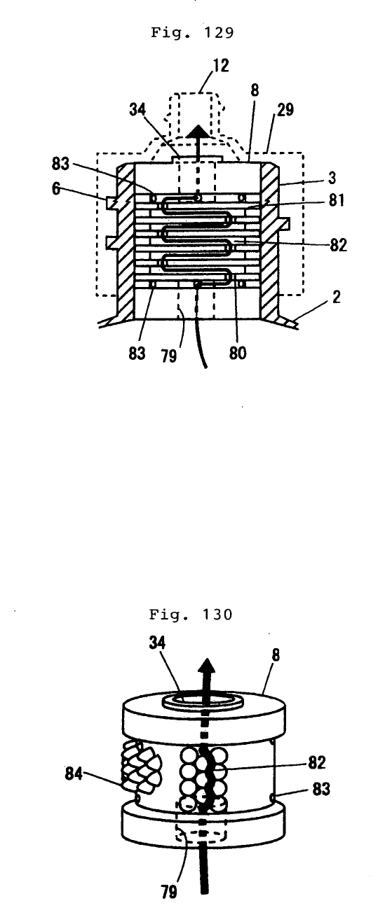

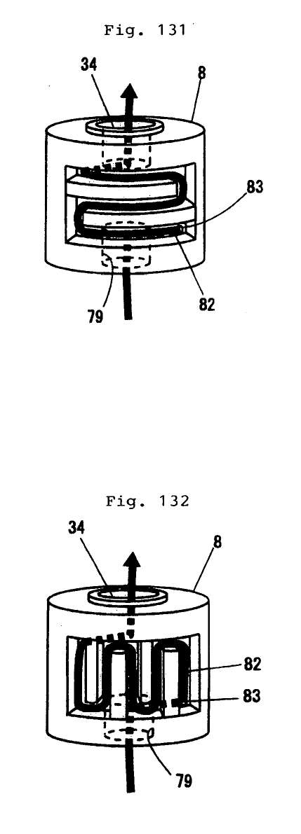

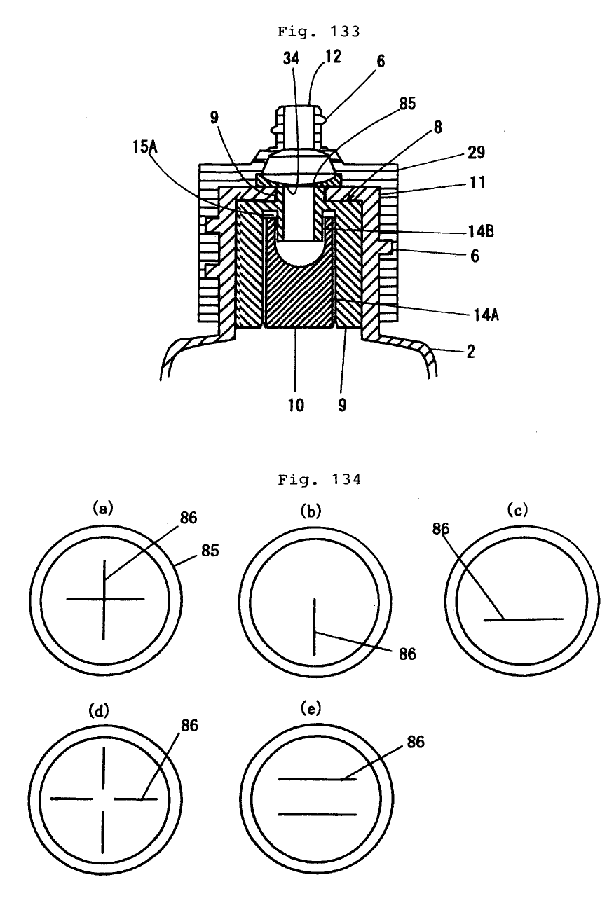

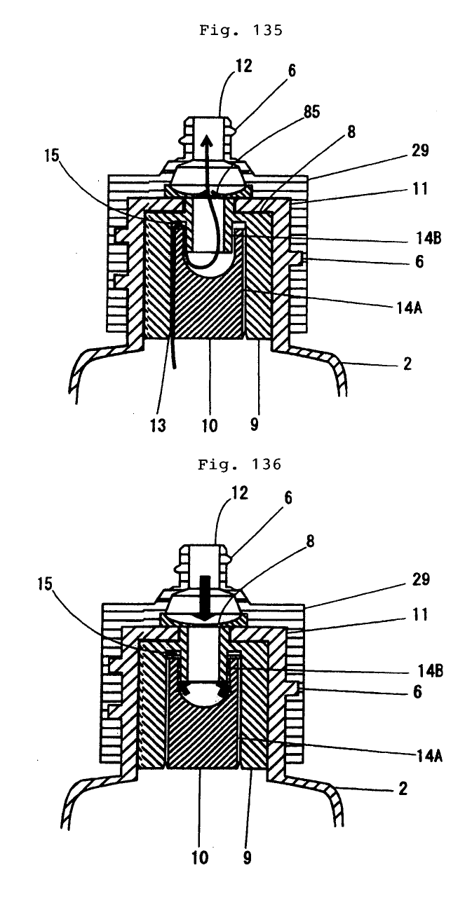

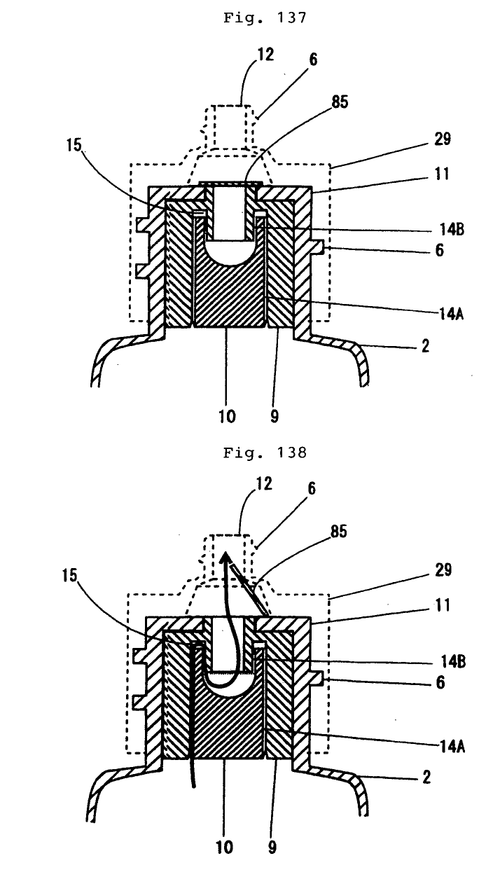

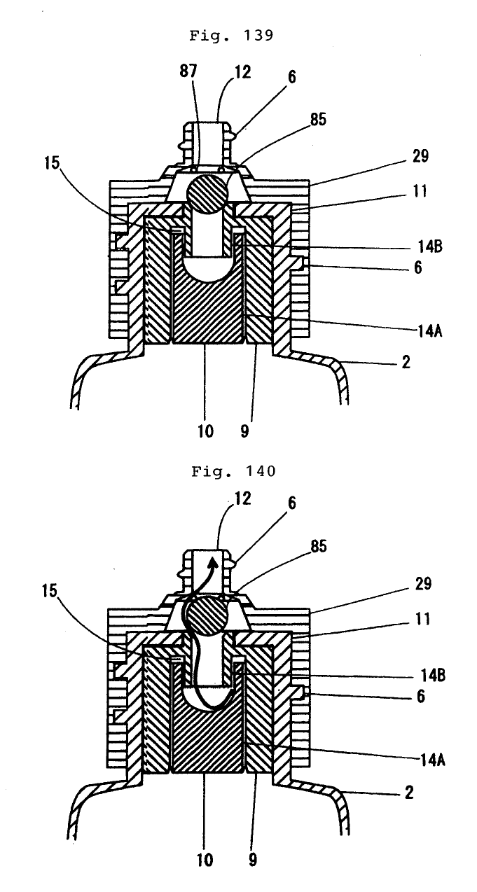

1. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates at all times the discharge nozzle from an inlet on the side of a container body to a discharge opening and is partially composed of a gap channel defined by a plurality of faces, and the gap channel is of such dimensions that a contents liquid stagnates under normal pressure due to a viscosity or surface tension of the contents liquid and does not easily flow therethrough, whereby contents can be discharged by pressing the container body at the time of discharge, while contents in the liquid channel of the discharge nozzle and the outer air are prevented from flowing back into the container body when the pressing force is released.

2. The always-open-type discharge nozzle with a function for preventing a backflow of contents as set forth in claim 1, wherein
the plurality of faces forming the gap are curved faces.

3. The always-open-type discharge nozzle with a function for preventing a backflow of contents as set forth in claim 1, wherein
the plurality of faces forming the gap are plane faces.

4. The always-open-type discharge nozzle with a function for preventing a backflow of contents as set forth in claim 1, wherein
the plurality of faces forming the gap are spherical faces.

5. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a minute channel having a minute cross-section, and the minute channel is of such dimensions that a contents liquid stagnates under normal pressure due to a viscosity or surface tension of the contents liquid and does not easily flow therethrough, whereby contents can be discharged by pressing the container body at the time of discharge, while contents in the liquid channel of the discharge nozzle and the outer air are prevented from flowing back into the container body when the pressing force is released.

6. The always-open-type discharge nozzle with a function for preventing a backflow of contents as set forth in claim 5, wherein
the minute channel is formed by a thread groove and a face.

7. The always-open-type discharge nozzle with a function for preventing a backflow of contents as set forth in claim 5, wherein
the minute channel is formed by protruded threads and a face.

8. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening, the liquid channel is of such narrow dimensions that contents stagnate in the channel under normal pressure due to a viscosity or surface tension of the contents and do not easily flow therethrough, and, the liquid channel has a reverse flow channel for a flowing of at least one time in a direction opposite to a discharging direction toward the discharge opening from a container body, whereby contents can be discharged by pressing the container body at the time of discharge, while contents in the liquid channel of the discharge nozzle and the outer air are prevented from flowing back into the container body when the pressing force is released.

9. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening, the liquid channel is of such narrow dimensions that contents stagnate in the channel under normal pressure due to a viscosity or surface tension of the contents and do not easily flow therethrough, and, the liquid channel has a bending channel for bending at least one time a flow direction of the contents with respect to a discharging direction toward the discharge opening from the container body, whereby contents can be discharged by pressing the container body at the time of discharge, while contents in the liquid channel of the discharge nozzle and the outer air are prevented from flowing back into the container body when the pressing force is released.

10. The always-open-type discharge nozzle with a function for preventing a backflow of contents as set forth in claim 8, wherein
a part of the liquid channel is composed of a gap channel defined by a plurality of faces.

11. The always-open-type discharge nozzle with a function for preventing a backflow of contents as set forth in claim 8, wherein
a part of the liquid channel is a minute channel having a minute cross-section.

12. The always-open-type discharge nozzle with a function for preventing a backflow of contents as set forth in claim 11, wherein
the minute channel is formed by a thread groove and a face.

13. The always-open-type discharge nozzle with a function for preventing a backflow of contents as set forth in claim 11, wherein
the minute channel is formed by protruded threads and a face.

14. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces and a minute channel having a minute cross-section, and the gap channel and the minute channel are of such dimensions that a contents liquid stagnates under normal pressure due to a viscosity or surface tension of the contents liquid and does not easily flow therethrough, whereby contents can be discharged by pressing the container body at the time of discharge, while contents in the liquid channel of the discharge nozzle and the outer air are prevented from flowing back into the container body when the pressing force is released.

15. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces or a minute channel having a minute cross-section, and, the channel forms a reciprocating channel having a backflow channel for a flowing of at least one time in a direction opposite to a discharging direction toward the discharge opening from the container body, and the gap channel is of such dimensions that a contents liquid stagnates under normal pressure due to a viscosity or surface tension of the contents liquid and does not easily flow therethrough, whereby contents can be discharged by pressing the container body at the time of discharge, while contents in the liquid channel of the discharge nozzle and the outer air are prevented from flowing back into the container body when the pressing force is released.

16. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces or a minute channel having a minute cross-section, and, the channel has a bending channel for bending at least once a flow direction of contents with respect to a discharging direction toward the discharge opening from the container body, and the gap channel is of such dimensions that a contents liquid stagnates under normal pressure due to a viscosity or surface tension of the contents liquid and does not easily flow therethrough, whereby contents can be discharged by pressing the container body at the time of discharge, while contents in the liquid channel of the discharge nozzle and the outer air are prevented from flowing back into the container body when the pressing force is released.

17. An always-open-type discharge nozzle with a function for preventing a backflow of contents, which is to be provided at a discharge opening of a flexible container to be deformed by external pressure to discharge the contents, wherein
the discharge nozzle has a liquid channel, which penetrates the discharge nozzle from an inlet on the side of a container body to a discharge opening and is partially composed of a gap defined by a plurality of faces and a minute channel having a minute cross-section, and, the channel forms a reciprocating channel having a backflow channel for a flowing of at least one time in a direction opposite to a discharging direction toward the discharge opening from the container body, and the gap channel is of such dimensions that a contents liquid stagnates under normal pressure due to a viscosity or surface tension of the contents liquid and does not easily flow therethrough, whereby contents can be discharged by pressing the container body at the time of discharge, while contents in the liquid channel of the discharge nozzle and the outer air are prevented from flowing back into the container body when the pressing force is released.

18. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces and a minute channel having a minute cross-section, and, the channel has a bending channel for bending at least one a flow direction of contents with respect to a discharging direction toward the discharge opening from the container body, and the gap channel is of such dimensions that a contents liquid stagnates under normal pressure due to a viscosity or surface tension of the contents liquid and does not easily flow therethrough, whereby contents can be discharged by pressing the container body at the time of discharge, while contents in the liquid channel of the discharge nozzle and the outer air are prevented from flowing back into the container body when the pressing force is released.

19. The always-open-type discharge nozzle with a function for preventing a backflow of contents as set forth in claim 14, wherein
the plurality of faces forming the gap are curved faces.

20. The always-open-type discharge nozzle with a function for preventing a backflow of contents as set forth in claim 14, wherein
the plurality of faces forming the gap are plane faces.

21. The always-open-type discharge nozzle with a function for preventing a backflow of contents as set forth in claim 14, wherein
the plurality of faces forming the gap are spherical faces.

22. The always-open-type discharge nozzle with a function for preventing a backflow of contents as set forth in claim 14, wherein
the minute channel is formed by a thread groove and a face.

23. The always-open-type discharge nozzle with a function for preventing a backflow of contents as set forth in claim 14, wherein
the minute channel is formed by protruded threads and a face.

24. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to a viscosity or surface tension of the contents liquid and does not easily flow therethrough so as to restrict a flow of the contents in a normal condition, and, the channel secures a sufficiently long tube length in a limited space of a container discharge opening by being provided with two or more reverse flow channels for a flowing of at least one time in a direction opposite to an outflow direction toward the discharge opening from the container body, whereby contents can be discharged by pressing the container body at the time of discharge, while contents in the liquid channel of the discharge nozzle and the outer air are prevented from flowing back into the container body when the pressing force is released.

25. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to a viscosity or surface tension of the contents liquid and does not easily flow therethrough so as to restrict a flow of contents in a normal condition, and, the channel secures a sufficiently long tube length in a limited space of a container discharge opening by being provided with a discharge channel for reaching the discharge opening while reversing in direction orthogonal to an outflow direction toward the discharge opening from the container body, whereby contents can be discharged by pressing the container body at the time of discharge, while contents in the liquid channel of the discharge nozzle and the outer air are prevented from flowing back into the container body when the pressing force is released.

26. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to a viscosity or surface tension of the contents liquid and does not easily flow therethrough so as to restrict a flow of contents in a normal condition, and, the channel secures a sufficiently long tube length in a limited space of a container discharge opening by being formed into a helicoidal shape, whereby contents can be discharged by pressing the container body at the time of discharge, while contents in the liquid channel of the discharge nozzle and the outer air are prevented from flowing back into the container body when the pressing force is released.

27. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to a viscosity or surface tension of the contents liquid and does not easily flow therethrough so as to restrict a flow of contents in a normal condition, and, the channel secures a sufficiently long tube length in a limited space of a container discharge opening by being formed into a spiral shape, whereby contents can be discharged by pressing the container body at the time of discharge, while contents in the liquid channel of the discharge nozzle and the outer air are prevented from flowing back into the container body when the pressing force is released.

28. An always-open-type discharge nozzle with a function for preventing a backflow of contents, which is to be provided at a discharge opening of a flexible container to be deformed by external pressure to discharge contents, wherein
the discharge nozzle has a liquid channel, which penetrates the discharge nozzle from an inlet on the side of a container body to a discharge opening and is partially composed of a gap defined by a plurality of faces or a minute channel having a minute cross-section, and the channel is of such dimensions that a contents liquid stagnates under normal pressure due to a viscosity or surface tension of the contents liquid and does not easily flow therethrough so as to restrict a flow of contents in a normal condition, and, the channel secures a sufficiently long tube length in a limited space of a container discharge opening by being formed into a maze-like shape, whereby contents can be discharged by pressing the container body at the time of discharge, while contents in the liquid channel of the discharge nozzle and the outer air are prevented from flowing back into the container body when the pressing force is released.

29. A discharge nozzle with a function for preventing a backflow of contents, which is to be provided at a discharge opening of a flexible container to be deformed by external pressure to discharge contents, wherein
the discharge nozzle has a liquid channel, which is partially composed of a gap defined by a plurality of faces or a minute channel having a minute cross-section, the liquid channel is of such dimensions that a contents liquid stagnates under normal pressure due to a viscosity or surface tension of the contents liquid and does not easily flow therethrough, and a check valve is provided at a discharge opening portion, whereby contents can be discharged by pressing the container body at the time of discharge, while contents in the liquid channel of the discharge nozzle and the outer air are prevented from flowing back into the container body when the pressing force is released.

30. The discharge nozzle with a function for preventing a backflow of contents as set forth in claim 29, wherein
the check valve is an elastic body provided with at least one slit which is closed in a normal condition.

31. The discharge nozzle with a function for preventing a backflow of contents as set forth in claim 29, wherein
the check valve is a plate-like valve which shuts the discharge opening portion of the nozzle in a normal condition.

32. The discharge nozzle with a function for preventing a backflow of contents as set forth in claim 29, wherein
the check valve is a ball- or piece-like valve which shuts the discharge opening portion of the nozzle in a normal condition.

33. A liquid container provided with the discharge nozzle with a function for preventing a backflow of contents as set forth in claim 1.

34. The always-open-type discharge nozzle with a function for preventing a backflow of contents as set forth in claim 9, wherein
a part of the liquid channel is composed of a gap channel defined by a plurality of faces.

35. The always-open-type discharge nozzle with a function for preventing a backflow of contents as set forth in claim 9, wherein
a part of the liquid channel is a minute channel having a minute cross-section.

36. The always-open-type discharge nozzle with a function for preventing a backflow of contents as set forth in claim 15, wherein
the plurality of faces forming the gap are curved faces.

37. The always-open-type discharge nozzle with a function for preventing a backflow of contents as set forth in claim 15, wherein
the plurality of faces forming the gap are plane faces.

38. The always-open-type discharge nozzle with a function for preventing a backflow of contents as set forth in claim 15, wherein
the minute channel is formed by a thread groove and a face.

39. The always-open-type discharge nozzle with a function for preventing a backflow of contents as set forth in claim 15, wherein
the minute channel is formed by protruded threads and a face.

40. The always-open-type discharge nozzle with a function for preventing a backflow of contents as set forth in claim 16, wherein
the plurality of faces forming the gap are curved faces.

41. The always-open-type discharge nozzle with a function for preventing a backflow of contents as set forth in claim 16, wherein
the plurality of faces forming the gap are plane faces.

42. The always-open-type discharge nozzle with a function for preventing a backflow of contents as set forth in claim 16, wherein
the minute channel is formed by a thread groove and a face.

43. The always-open-type discharge nozzle with a function for preventing a backflow of contents as set forth in claim 16, wherein
the minute channel is formed by protruded threads and a face.

44. The always-open-type discharge nozzle with a function for preventing a backflow of contents as set forth in claim 17, wherein
the plurality of faces forming the gap are curved faces.

45. The always-open-type discharge nozzle with a function for preventing a backflow of contents as set forth in claim 17, wherein
the plurality of faces forming the gap are plane faces.

46. The always-open-type discharge nozzle with a function for preventing a backflow of contents as set forth in claim 17, wherein
the minute channel is formed by a thread groove and a face.

47. The always-open-type discharge nozzle with a function for preventing a backflow of contents as set forth in claim 17, wherein
the minute channel is formed by protruded threads and a face.

48. The always-open-type discharge nozzle with a function for preventing a backflow of contents as set forth in claim 18, wherein
the plurality of faces forming the gap are curved faces.

49. The always-open-type discharge nozzle with a function for preventing a backflow of contents as set forth in claim 18, wherein
the plurality of faces forming the gap are plane faces.

50. The always-open-type discharge nozzle with a function for preventing a backflow of contents as set forth in claim 18, wherein
the minute channel is formed by a thread groove and a face.

51. The always-open-type discharge nozzle with a function for preventing a backflow of contents as set forth in claim 18, wherein
the minute channel is formed by protruded threads and a face.

52. A liquid container provided with the discharge nozzle with a function for preventing a backflow of contents as set forth in claim 8.

53. A liquid container provided with the discharge nozzle with a function for preventing a backflow of contents as set forth in claim 14.

54. A liquid container provided with the discharge nozzle with a function for preventing a backflow of contents as set forth in claim 15.

55. A liquid container provided with the discharge nozzle with a function for preventing a backflow of contents as set forth in claim 16.

56. A liquid container provided with the discharge nozzle with a function for preventing a backflow of contents as set forth in claim 17.

57. A liquid container provided with the discharge nozzle with a function for preventing a backflow of contents as set forth in claim 18.

58. A liquid container provided with the discharge nozzle with a function for preventing a backflow of contents as set forth in claim 24.

59. A liquid container provided with the discharge nozzle with a function for preventing a backflow of contents as set forth in claim 25.

60. A liquid container provided with the discharge nozzle with a function for preventing a backflow of contents as set forth in claim 26.

61. A liquid container provided with the discharge nozzle with a function for preventing a backflow of contents as set forth in claim 27.

62. A liquid container provided with the discharge nozzle with a function for preventing a backflow of contents as set forth in claim 28.

63. A liquid container provided with the discharge nozzle with a function for preventing a backflow of contents as set forth in claim 29.
